(19) United States
(12) Patent Application Publication
(10) Pub. No.: US 2026/0222233 A1
(43) Pub. Date: Jul. 30, 2026

(54) DELAYED PROOF OF VALIDITY

(71) Applicant: BTQ AG, Vaduz (LI)

(72) Inventors: Po-Chun KUO, Taipei City (TW); Chen-Mou CHENG, Taipei City (TW)

(21) Appl. No.: 19/140,064

(22) PCT Filed: Dec. 19, 2023
(86) PCT No.: PCT/EP2023/086754

§ 371 Date: Jun. 17, 2025

(30) Foreign Application Priority Data
Dec. 19, 2022 (EP) 22214465.1

(51) Int. Cl. H04L 9/00; G06F 16/23; H04L 9/32

(52) U.S. Cl. CPC H04L 9/50; G06F 16/2379; H04L 9/3218; H04L 9/3247

(57) ABSTRACT

Methods and systems for delaying generation and integration of proofs of validity into a block of a blockchain, operated by a network, each proof of validity associated with a plurality of different transactions are disclosed. The method may comprise receiving a plurality of different transactions, each transaction comprising transactions data and associated validity data; producing a plurality of new blocks on the blockchain, the new blocks comprising the transaction data; generating in parallel, during a predetermined time, one or more proofs of validity associated with one or more blocks from the plurality of new blocks, based on associated validity data; and incorporating, after the predetermined time, the one or more proofs of validity in the blockchain.

### FIELD OF THE INVENTION

The present disclosure relates generally to blockchain technology, and in particular to a system and a method for dealing with limitations to current blockchain formats with proving systems.

### BACKGROUND OF THE INVENTION

Blockchain networks, such as decentralised cryptocurrency networks must verify the legitimacy of transactions before recording them to the blockchain. To validate the authenticity of transactions, some blockchains use proofs of validity, i.e. summary data obtained by processing generally large data sets associated with transactions, confirming the validity of the latter. Proofs of validity are typically used to enforce privacy and improve scalability. Since each block relies on some proof of validity, the amount of time required to produce the block and add it to the blockchain must be at least as long as the time required to generate that proof. However, as threats to break the security mechanisms currently applied in blockchain technology are becoming increasingly sophisticated, proofs of validity are becoming more complex, and depending on the level of security of the underlying proofs, the time required to generate those proofs is increasing. Proof generation increasingly requires a duration of time that slows down the generation of blockchain blocks, which affects the usability of the blockchain for certain applications. Accordingly, there is a need to find a way to mitigate the latency introduced to blockchains by proof systems that require more time to generate a proof than the time required to produce a new block.

At least some of the embodiments of the present disclosure provide a solution to the above-mentioned problem, and can be implemented in any system using proving systems in which proofs of validity are published sequentially, and proof generation acts as a bottleneck to the generation of new blocks in a blockchain.

### SUMMARY OF THE INVENTION

In accordance with an aspect of the disclosure, there is provided a method of generating a proof of validity associated with one or more transactions associated with one or more existing blocks of a blockchain. The method may comprise receiving a plurality of validity data. Each validity data may be associated with a different transaction associated with the one or more existing blocks of the blockchain. The method may further comprise generating one or more proofs of validity associated with the plurality of validity data and incorporating the generated one or more proofs of validity into a block of the blockchain.

At least some of the herein-disclosed embodiments, by decorrelating proof of validity generation from block generation, may provide a reduction in the latency introduced to block generation by proof systems, when compared to prior art solutions which require that each newly generated block comprise a proof of validity. For increasingly complex proof of validities, the proof of validity calculation itself may introduce a significant latency in the prior art block generation process. This problem is likely to be exasperated as increasingly sophisticated and complex block generation and validity proofs are implemented to defend against increasingly sophisticated cyber threats from fraudulent users having ever increasing processing resources available to them.

In accordance with some embodiments, the generated one or more proofs of validity may be retrospectively incorporated into one or more existing blocks of the blockchain. The one or more existing blocks may be associated with the transactions in respect of which the one or more proofs of validity are associated.

In some of the herein-disclosed embodiments, generating one or more proofs of validity may include performing a cost-benefit analysis in respect of the proof of validity generation process. If the outcome of the cost-benefit analysis is positive, then the one or more proofs of validity may be generated. The cost-benefit analysis may be based on at least one of a potential reward for the miner, time efficiency, processing efficiency, storage efficiency, energy consumption, or a combination thereof. In some embodiments, the outcome of the cost-benefit analysis may be positive if the potential reward for the miner generating the one or more proofs of validity offsets an energy cost for generating the one or more proofs of validity. Additionally, or alternatively, the outcome of the cost-benefit analysis may be positive if a space-saving resulting from the storage of the one or more generated proofs of validity compared with the storage requirement for the associated validity data, is greater than a threshold amount. In some embodiments, the outcome of the cost-benefit analysis may be positive if a space-saving resulting from the storage of the one or more generated proofs of validity compared with the storage requirement for the associated validity data offset an energy cost for generating the one or more proofs of validity.

In accordance with some embodiments, the generated one or more proofs of validity may be incorporated into a block of the blockchain currently being generated. The one or more proofs of validity enabling verification of transaction data comprised in the one or more existing blocks comprised in the blockchain.

In some embodiments, the one or more existing blocks may precede the block currently being generated by a time period equal to or greater than the time required to generate the one or more proofs of validity. The one or more existing blocks may precede the block currently being generated by a predetermined number of blocks on the blockchain. The time taken to generate the predetermined number of blocks may be proportional to a time period equal to or greater than the time required to generate the one or more proofs of validity. The time period may be parametrized by at least two parameters k and j, and the time period may be equal to k±j. Additionally, the value of the parameter k may be dependent on a computing power associated with at least one miner linked to the blockchain, and the parameter j may be associated with the stability of the blockchain network.

In some embodiments, the plurality of validity data may be received from a database accessible to one or more miners comprised in a blockchain network. In some embodiments, the plurality of validity data may be received from a database distributed across a plurality of nodes comprised in a blockchain network. In some embodiments, the plurality of validity data may be received from a peer-to-peer distributed database. In some embodiments, the database may exclusively comprise validity data.

In at least some embodiments, the received plurality of validity data may include a plurality of signature data sᵢ. Each signature data may be associated with a different transaction associated with the one or more existing blocks of the blockchain. Each transaction may be associated with a public key, pkᵢ, and private key, skᵢ, pair, the public and private key pair being selected using a digital signature scheme. The signature data, Sᵢ, associated with a transaction may be generated by encrypting the transaction data, TXᵢ, associated with the transaction, using the private key, skᵢ, associated with the transaction.

In accordance with some embodiments, the digital signature scheme may be any one or more of: a multi-use signature scheme, a post-quantum digital signature scheme, a lattice-based cryptographic digital signature scheme. The lattice-based cryptographic digital signature scheme may be a hash-and-sign lattice-based cryptographic digital signature scheme, such as the Falcon signature scheme.

Generating one or more proofs of validity may comprise aggregating the plurality of signature data using an aggregation algorithm to produce one or more aggregated signatures.

In some of the herein disclosed embodiments, a size of each of the one or more aggregated signatures may be smaller than the combined sizes of the individual signature data being aggregated. The size of the one or more aggregated signatures may be sublinear in relation to the total number of signature data being aggregated. Additionally or alternatively the size may scale logarithmically with respect to the total number of signature data being aggregated.

In accordance with some embodiments, the method may further comprise: receiving a plurality of different transactions, each transaction comprising transaction data; and generating a plurality of new blocks in parallel on the blockchain, the plurality of new blocks including the transaction data.

In accordance with another aspect of the disclosure, there is provided a server comprising at least one processor configured to receive a plurality of validity data. Each validity data may be associated with a different transaction associated with the one or more existing blocks of the blockchain. The at least one processor may be further configured to generate one or more proofs of validity associated with the plurality of validity data, and incorporate the generated one or more proofs of validity into a block of the blockchain.

In accordance with some embodiments, the at least one processor of the server may be configured to carry out the aforementioned methods.

The foregoing general description and the following detailed description are exemplary and explanatory only and are not restrictive of the claims.

### BRIEF DESCRIPTION OF THE DRAWINGS

Exemplary, non-limiting embodiments of the disclosure will be described with reference to the appended figures in which:

FIG. 1 is a schematic diagram of a networked computer system implementing a traditional blockchain network;

FIG. 2 is a schematic diagram of a blockchain generated by the system of FIG. 1, illustrating the general structure and properties of a blockchain block;

FIG. 3 is a schematic diagram of a networked computer system in accordance with embodiments of the present disclosure, configured to implement the herein disclosed methods;

FIG. 4 is a schematic diagram of an exemplary modified blockchain generated by the system of FIG. 3, in accordance with embodiments of the disclosure;

FIG. 5A is a schematic comparative diagram illustrating how a time-delayed proof of validity of a single block of a blockchain is stored using immutable blocks, in accordance with herein disclosed methods, compared to how validity proofs are stored in a known blockchain;

FIG. 5B is a schematic comparative diagram illustrating how a plurality of time-delayed proofs of validity associated with at least two blocks of a blockchain are stored using immutable blocks, in accordance with herein disclosed methods, compared with how validity proofs are stored in a known blockchain;

FIG. 5C is a process flowchart illustrating a method of generating a validity proof for the immutable blocks of FIGS. 5A and 5B, in accordance with one or more embodiments;

FIG. 6 is a schematic diagram of an alternative networked computer system configured to implement the herein disclosed methods, the networked computer system comprising a single database storing validity data and transaction data, in accordance with one or more embodiments of the present disclosure;

FIG. 7A is a schematic diagram of another modified blockchain prior to validity proof generation, in accordance with one or more embodiments of the disclosure;

FIG. 7B is a schematic diagram of the modified blockchain of FIG. 7A, after a time-delayed proof of validity has been generated, in accordance with herein disclosed methods;

FIG. 8A is a schematic comparative diagram illustrating how a plurality of time-delayed proofs of validity associated with at least two blocks of a blockchain may be retrospectively stored in previously generated blocks of a blockchain using mutable blocks, in accordance with herein disclosed methods, compared with how validity proofs are stored in a known blockchain;

FIG. 8B is a process flowchart illustrating validity proof generation for the mutable blocks of FIG. 8A, in accordance with herein-disclosed embodiments;

FIG. 9 is a process flowchart illustrating an exemplary cost-benefit analysis used to determine whether to generate a validity proof, in accordance with the herein-disclosed embodiments;

FIG. 10A is a process flowchart illustrating a method of incorporating a validity proof into a blockchain, in accordance with embodiments of the disclosure.

FIG. 10B is a process flowchart illustrating a method of incorporating a validity proof into a blockchain in parallel with the generation of new blocks, in accordance with embodiments of the disclosure.

### DETAILED DESCRIPTION

The following detailed description includes references to the accompanying drawings. Wherever possible, the same reference numbers are used in the drawings and the description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Embodiments disclosed herein relate to methods for time-delaying the generation of a proof of validity associated with a block of a blockchain, and integration of the proof of validity, into a block of a blockchain, without disrupting or otherwise delaying the creation of new blocks in the blockchain. The herein-disclosed methods may be implemented in a blockchain network.

The following disclosure begins with an overview of conventional blockchain systems to provide the reader with background information required to better understand the present disclosure. This overview aims to facilitate the reader's comprehension of the existing blockchain structure and processes. Subsequent sections disclose specific implementation details of the present methods for time-delaying the generation of a proof of validity, and integrating this validity proof into a block of a blockchain. Details are also provided of how the herein-disclosed methods for delaying proof of validity may be implemented by a blockchain miner server.

The outline of the contents of the remaining description is set out below.
1. Conventional Blockchain System Overview
2. Conventional structure of blockchains
3. Conventional structure of blockchain blocks
   a) General structure and properties of the transaction data comprised in a conventional (e.g. Bitcoin) blockchain.
4. Blockchain and proving systems
   a) Latency introduced by generating proofs of validity
   b) Digital signatures
5. Solution provided by the present disclosure
   a) Immutable blocks
      1. Working principle
      2. Example
   b) Mutable blocks
      1. Working principle
      2. Example
6. Proof of validity generation exemplary process: signature aggregation
7. Implementations in physical devices
8. Miscellaneous

### 1. Conventional Blockchain System Overview

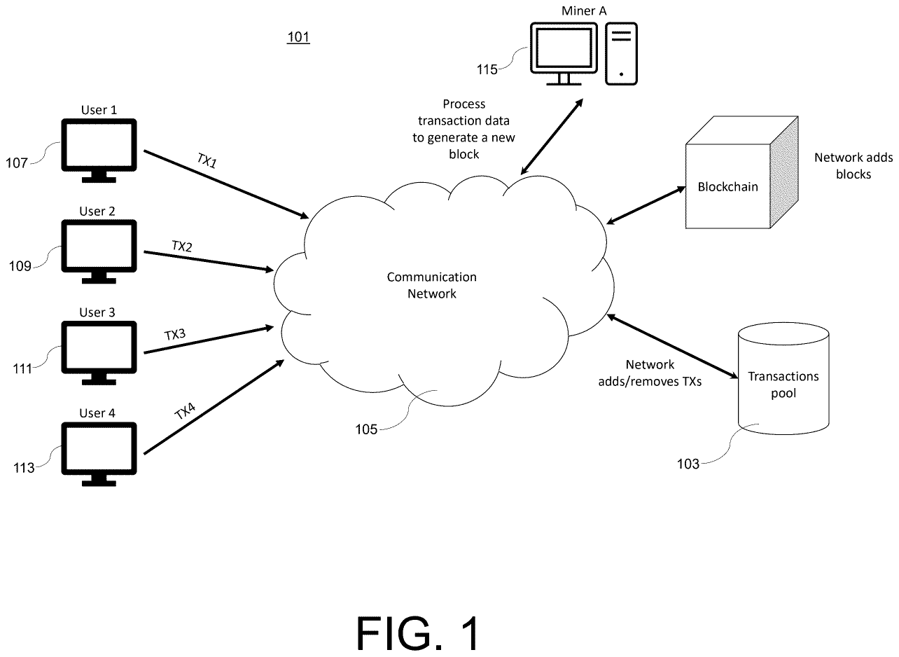

FIG. 1 is a schematic illustration of a networked computer system 101 configured to implement a traditional blockchain. For example, such a blockchain may serve as a digital ledger for electronic transactions, although it is to be appreciated that in principle any type of data may be stored on the blockchain.

Electronic transaction data generated by different users is collected together in a transaction pool repository 103, via a shared communication network 105. For example, first transaction data TX1 associated with a first user at a first user terminal 107, second transaction data TX2 associated with a second user at a second user terminal 109, third transaction data TX3 associated with a third user at a third user terminal 111, and fourth transaction data TX4 associated with a fourth user at a fourth user terminal 113, are sent to the transaction pool 103 via the shared communication network 105. Transaction data received by the transaction pool 103 is stored, and subsequently processed by at least one blockchain miner server 115.

Once a predetermined threshold condition is satisfied, at least one blockchain miner server 115 obtains a plurality of the transaction data (TX1 . . . TX4) stored in the transaction pool 103. For example, the predetermined threshold condition may relate to a predetermined number of electronic transactions stored at the transaction pool 103. The obtained transaction data is bulk processed by at least one blockchain miner server 115. Alternatively, at least one blockchain miner server 115 is provided with the plurality of transaction data once the threshold condition has been satisfied. The obtained, or received transaction data, as the case may be, is processed to generate a new block to be added to an existing blockchain, and/or to generate a block of a new blockchain. The at least one blockchain miner server 115 processes the transaction data to generate a proof of validity associated with the different electronic transactions. The blockchain itself may additionally comprise the transaction data, such that the resulting blockchain comprises both the electronic transaction data and the associated validity proof. This enables the electronic transaction data comprised on the blockchain to be verified using the proof of validity.

It is to be appreciated that whilst the system of FIG. 1 illustrates a single blockchain miner server 115, typically a blockchain network will comprise a plurality of different blockchain miner servers, the different blockchain miner servers competing to generate the next block in the blockchain and the associated validity proof.

### 2. Conventional Structure of Blockchains

By way of background, a blockchain is a distributed ledger representing all transactions that take place within the network. Transaction data is permanently stored in files called blocks, and blocks are organised linearly in a chain-like structure over time, referred to as a “blockchain.” As new transactions take place, new blocks are created and appended to the end of the blockchain. Accordingly, the blockchain provides a ledger comprising a record of all transactions that have occurred over time. This is the fundamental structure of a blockchain.

### 3. Conventional Structure of Blockchain Blocks

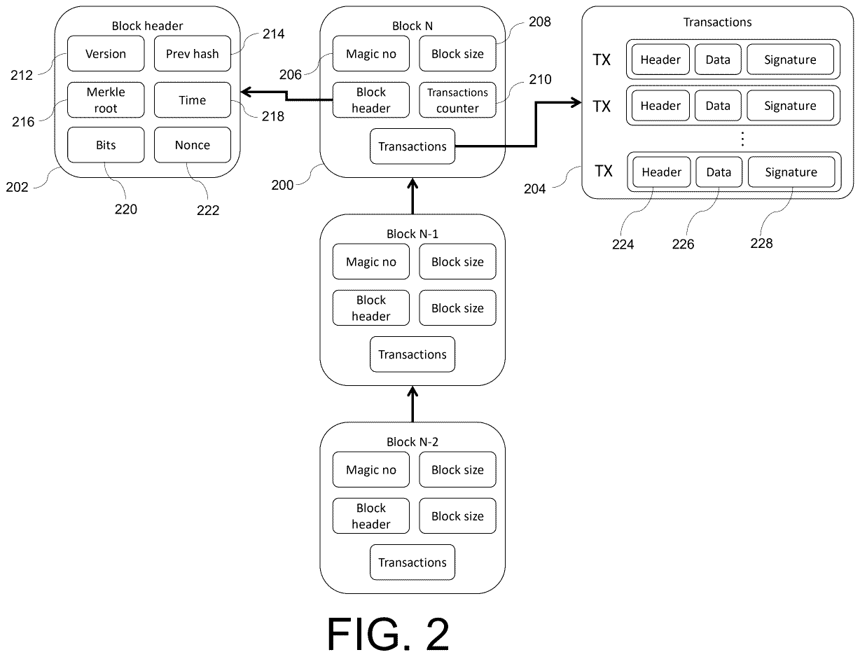

The structure of the blocks comprised in the blockchain is now described. As illustrated in FIG. 2, each block can be separated into three sections:
Block metadata 200
Block header 202
Transaction data 204

Block metadata 200 may comprise the general properties of the current block. This may include, but is not limited to:
Magic number (file signature) 206—Indicates the type of data contained in the file. Same for all blocks belonging to the same blockchain.
Size of the current block 208—Number of bytes following up to the end of block.
Number of transactions in the current block 210.

A block header describes particular properties of the current block such as its time and position. This may include but is not limited to:
Block version 212—Specifies current version of the blockchain software.
Hash of previous block header 214—Reference to the previous block.
Hash of all transactions in the block 216—Merkle root hash of all transactions in block.
Timestamp 218—Current block timestamp Unix time (seconds since 1970-01-01T00:00 UTC).
Bit difficulty 220—Current mining difficulty target.
Nonce 222—Number of attempts to solve Proof-of-Work (starts at 0).
   a) General Structure and Properties of the Transaction Data Comprised in a Conventional (e.g. Bitcoin) Blockchain

Transactions represent a transfer of some resource between two or more accounts on the blockchain. In some embodiments, the resource may relate to a financial resource, such as a transfer of funds. A transaction references previous transaction outputs as new transaction inputs and dedicates all underlying currency values to new outputs. This is formally realised as a state transition function, where each state represents the ownership status of all digital currency in circulation. It should be noted that a blockchain may comprise any type of transaction data, but for the non-limiting purpose of describing the invention, it is assumed that the blockchain is being used as a ledger for financial transactions. The schematic representation of how transaction data 204 is stored in a block of a typical blockchain is illustrated in FIG. 2. Transaction data 204 is stored in three groups:
Header 224—Contains instructions for sending the underlying currency. Includes a hash of a previous transaction and the output of the referenced transaction. The output of the referenced transaction is used as input to the current transaction.
Data 226—Recipient public key.
Digital signature 228—An ECDSA signature over a hash of a simplified version of the transaction. This is used to prove that the transaction was created by the real owner of the underlying currency involved in the transaction.

Note the one-to-one relationship between each transaction and ECDSA digital signature.

### 4. Blockchain and Proving Systems

### a) Latency Introduced by Generating Proofs of Validity

Proof generation is carried out with respect to a proving system that allows one to “prove” things about the world without disclosing complete information about what is being proved. This has favourable properties for data privacy systems where users may wish to obscure sensitive information from unintended parties. Such a technique is also useful for reducing space requirements in space-constrained digital systems by providing a proof of validity for some piece of information rather than providing the raw bit string length of information. In these proving systems, proof generation is often a computationally expensive operation leading to potentially prohibitive latencies in downstream operations. Technologies such as distributed ledger technology, or blockchains, are particularly impacted by these latencies. The following is a description of how latency issues are introduced into a blockchain system where the amount of time to generate a proof of validity for some validity data in a block is greater than the amount of time for the blockchain network to generate a new block. Assume that a proving system generates a proof for some piece of information in a block to reduce the number of bytes required to store that information on-chain. This requires that the next block cannot be produced until all of the information in the current block is finalised (i.e. has a proof of validity generated for) since the next block references the current block via a hash of all the data in the current block. This becomes the case for every block thereafter, where the time required to produce a new block is dependent on the amount of time required to generate a proof of validity for the data comprised in the block. Digital signatures are an example of validity data a miner inspects to create a proof of validity.

### b) Digital Signatures

Digital signatures are the results of asymmetric cryptography schemes, a type of cryptographic technique where a key used for encrypting data (private key) is distinct from a key used for decrypting the data (public key). Asymmetric cryptography schemes are also known as digital signature schemes.

In a public/private key scheme or digital signature scheme, a sender follows a specific process to ensure confidentiality, authenticity, and non-repudiation of a message being sent to a receiver. The following steps may be comprised in the process:
1. Message Signing with the Sender's Private Key: The sender first signs the message using their private key. This process involves creating a digital signature of the message. The digital signature is a unique cryptographic representation of the message that is generated using the sender's private key. It provides a means of proving that the message was sent by the sender possessing the private key and that the message has not been altered in transit.
2. Message Encryption with the Receiver's Public Key: After signing the message, the sender encrypts the entire message (including the digital signature) using the receiver's public key. The public key is part of the recipient's public/private key pair. Since the public key is meant to be freely distributed, anyone can use it to encrypt messages intended for the recipient.
3. Sending the Encrypted and Signed Message: The sender then sends the encrypted and signed message to the recipient. The recipient is the only one who possesses the corresponding private key that can decrypt the message and verify the digital signature.
4. Recipient's Decryption and Signature Verification: Upon receiving the message, the recipient uses their private key to decrypt the message and recover the original content, including the digital signature. The recipient can then verify the digital signature using the sender's public key, which is widely available. If the digital signature is valid, it confirms the message's authenticity and integrity, as only the sender's private key could have generated the signature.

A digital signature scheme corresponds therefore to a cryptographic algorithm that allows the creation and verification of digital signatures, providing a means of ensuring the authenticity and integrity of digital messages or data. It is to be appreciated that in some alternative processes, encryption is not mandatory.

A digital signature scheme may be defined by a set of algorithms (KeyGen, Sign, Verify) that function as follows:

KeyGen(λ)→(sk, pk): Taking λ as a security parameter to indicate a desired level of security as an input, the KeyGen algorithm produces a new random key pair (sk, pk)∈KS×KP, where sk is the private key or secret signing key, pk is the corresponding public verification key, KS a private key set, and KP a public key set.

Sign(sk, u)→s: Given the private key sk and a message μ (e.g., a transaction TX), the Sign algorithm generates a signature s∈S, with S representing a signature set.

Verify(pk, μ, s)→b∈{0, 1}: The Verify algorithm takes the public verification key pk, a message μ, and a signature s as inputs and outputs a bit b, indicating whether the signature s is valid for the given message u with the public verification key pk.

λ translates the level of security in digital signature schemes. It is a measure of how resistant the scheme is to various attacks, including brute-force attacks and sophisticated mathematical attacks. It quantifies the amount of computational effort required for an adversary to forge or break the digital signature, essentially determining the strength of the cryptographic scheme. The security level is commonly measured in bits and indicates the number of bits needed to represent the security parameter of the cryptographic scheme. For example, if a digital signature scheme has a security level of 128 bits, it means that an attacker would need to perform approximately 2128 operations to break the scheme using the best-known cryptanalytic algorithm, e.g., by using a brute-force attack. The security level is often associated with the key sizes and other parameters of the lattice used in the scheme. A higher security level usually requires larger key sizes and more complex mathematical operations to ensure resistance against attacks. Larger key sizes, in turn, may impact the size of the signature s. As used herein, a size, whether a signature size or a key size, refers to the number of bits or bytes needed to store a representation of the signature/key. The larger the signature/key size, the more data is needed to represent the cryptographic signature/key. The representation of a signature or a key may take different formats, such as a bit string or a hexadecimal string. These formats are common ways to represent the binary data that constitutes the signature/key in a human-readable or machine-readable form. The choice between bit string and hexadecimal string may depend on factors such as the desired readability, data size, ease of handling, and compatibility with existing systems or protocols.

In certain cryptographic schemes, a signature may be represented by multiple components s=(s1, . . . , sM), where M is the total number of signature components. Each part or component may have a specific purpose and contribute to the overall validity of the signature. In some cryptographic schemes, one of the signature components may correspond to the actual signature itself generated with the signer's private key, representing the core cryptographic proof of authenticity and integrity. The other components, on the other hand, may serve to reinforce the complexity or enhance the security of the overall scheme. These additional components may include various mathematical constructs or values derived from the actual signature, the private and public keys, the message being signed, or other cryptographic elements. By incorporating these extra components, the scheme may achieve certain security properties, such as resistance against specific types of attacks or increased protection.

It is also to be appreciated that signatures may be classified as either one-time-use or multi-use, based on their intended purpose and design. One-time-use signatures, as their name suggests, are meant for a single transaction or message. In these schemes, each key pair is limited to a single use, which significantly restricts their practical application. The reason behind this restriction is that using the same key pair to produce multiple signatures may compromise the security of the key pair, revealing it or portions of it to other users. As a result, one-time-use signatures are less commonly deployed in real-world scenarios. Conversely, in many practical applications, such as in blockchain technology, multi-use signature schemes are widely used. Examples of such schemes include RSA and ECDSA. In multi-use signature schemes, a single public key can be used for multiple transactions or messages, making them more efficient and suitable for large-scale deployment in various cryptographic protocols and systems.

As mentioned above, the purpose of the Verify algorithm is to perform computations to verify the signature's validity. This step may involve verifying certain mathematical relationships or constraints to ensure that the signature corresponds to the given message and was generated using the correct private key sk. It may as well use a message digest h(μ), which may correspond to a fixed-size digest or hash value of the message μ. Many verification algorithms are available, and the choice of the verification algorithm directly depends on the KeyGen and Sign algorithm selected. Some digital signature schemes may employ some cryptographically verifiable algorithms (e.g., RSA) to generate the signature, while others may employ some probabilistic proof algorithms or zero-knowledge proof algorithms.

Zero-knowledge proof (ZKP) algorithms are cryptographic protocols that allow one party (the prover) to prove to another party (the verifier) the validity of a statement without revealing any additional information (zero-knowledge) beyond the fact that the statement is true. In other words, the prover is providing proof of the validity of the statement to the verifier. One of the properties of a zero-knowledge proof is that it may be easily verifiable. The verifier should be able to efficiently verify the proof without needing to perform the same complex computation as the prover. ZKPs involve a private witness and a public instance, which may be used individually or in combination in the statement. The private witness is the secret information that the prover possesses and wants to prove knowledge of without revealing it to the verifier. The public instance, on the other hand, is the publicly available information. During the proof generation process, the prover uses the private witness and the public instance to construct the proof, which is then provided to the verifier. The verifier can then use the proof along with the public instance to verify the correctness of the proof without learning anything about the private witness.

In the context of digital signatures, ZKPs may be employed to prove the validity of a signature without revealing the actual contents of the signature or the private key used for signing (private witness). Zero-knowledge proofs are inherently probabilistic rather than deterministic. This probabilistic nature arises from the need for multiple rounds of interactions between the prover and the verifier to gradually build a higher level of assurance that the prover possesses the secret knowledge without revealing it. In these interactions, the verifier challenges the prover by asking specific questions or requesting computations that only someone with knowledge of the secret (e.g., private key or signature) could answer correctly.

As a result of these repeated interactions, ZKPs are often interactive protocols. During the interactions, the verifier poses challenges or questions to the prover, and the prover responds accordingly. The verifier accepts the proof only if the prover's responses demonstrate a deep understanding of the secret without actually disclosing the secret itself. However, this interactive reasoning may be transformed into a non-interactive protocol through the Fiat-Shamir Transform. This technique is employed to convert interactive identification protocols into non-interactive zero-knowledge proof systems. In this transformation, the verifier's random challenges are replaced with the result of a random oracle or a hash function (which the verifier can check to ensure that the prover has performed correctly to produce its randomness). This ensures that the challenges become unpredictable to the prover, guaranteeing the security of the non-interactive version and achieving the same effect as truly random verifier challenges. For instance, in a scenario where a signer (prover) has a function f and an image pk=f(sk) as their public key, they keep sk as their secret key. To sign a message u, the prover provides a non-interactive zero-knowledge proof that they know sk (private witness) satisfying pk=f(sk), using the message u to create the challenge H(μ) for the proof. Here, H is a public hash function or random oracle that maps μ to something “random looking”. If the function f is one-way, then the verifier can be convinced that the proof could only have been created by the entity who knows sk, ensuring the security of the non-interactive zero-knowledge proof system. Examples of ZKPs include Zero-Knowledge Succinct Non-Interactive Argument of Knowledge (zk-SNARK) and Zero-Knowledge Scalable Transparent Argument of Knowledge (zk-STARK).

Zero-knowledge proofs (ZKPs) may use various mathematical techniques or intermediate expressions to encode the statement to prove depending on the context and requirements of the zero-knowledge proof system and/or the statement needing to be proved. Intermediate representations serve as structured and condensed representations of computations, breaking down the computation into mathematical constraints, logical operations, or algebraic structures to achieve a more efficient and concise representation. For example, in the case of zk-SNARK (Zero-Knowledge Succinct Non-Interactive Argument of Knowledge) proofs, the statement is broken down into simple units of arithmetic operations, such as addition, subtraction, multiplication, and division. These operations are then presented in the form of an arithmetic circuit, where inputs and arithmetic operations are represented as wires and gates in a directed acyclic graph (DAG). This graph evaluates a polynomial by processing the inputs and performing the arithmetic operations on them.

Within the zk-SNARK protocol, several intermediate representations play valuable roles:
RICS (Rank 1 Constraint System): RICS is a set of constraints that allow the verification of each step in the arithmetic circuit and confirms that the output of the computation is as expected.
QAP (Quadratic Arithmetic Program): The prover utilizes QAPs to construct a proof of the statement. Instead of checking numerous individual constraints as in RICS, the QAP representation bundles all these constraints into a single constraint, making the verification more efficient.
Finally, QAP is employed in the zk-SNARK protocol to prove the assertion through interactions between the prover and verifier, providing a succinct and non-interactive argument of knowledge for the statement's validity.

The result of a ZKP algorithm may be a proof string or proof object, providing evidence to the verifier that the prover holds knowledge of a valid solution to a specific problem or statement. The proof is designed such that the verifier can efficiently verify its validity without gaining any knowledge about the prover's secret. When the proof is valid, the verifier can be assured that the prover indeed possesses the required knowledge without knowing any specifics about it. In the context of a digital signature scheme, the ZKP proof may be integrated as one of the components of the signature s and contribute to the overall size of the signature, or represent the signature s itself.

Traditional public-key cryptography relies on the difficulty of certain mathematical problems on classical computers, such as integer factorization or the discrete logarithm problem. However, the rise of quantum computers poses a threat to these cryptographic schemes as quantum computers may efficiently solve these problems, rendering current cryptographic algorithms vulnerable.

To address this potential threat, various post-quantum digital signature schemes have been developed. These schemes utilize mathematical structures like Euclidean lattices or symmetric-key primitives such as cryptographic hash functions, which are believed to be resistant to attacks even by large quantum computers.

In response to the growing concerns over quantum computers, the National Institute of Standards and Technology (NIST) initiated a process in 2016 to develop standards for post-quantum cryptography, including encryption and digital signature schemes. NIST's efforts to establish guidelines for post-quantum digital signatures aim to ensure that secure communication and digital authentication infrastructures remain robust and usable even in the presence of powerful quantum adversaries. In July 2022, NIST announced its plan to standardize three post-quantum digital signature schemes: Falcon, Dilithium, and SPHINCS+. However, it's worth noting that these post-quantum signature algorithms have larger public key and signature sizes compared to their pre-quantum counterparts like ECDSA, typically ranging from 30 to 100 times larger. As an example, for NIST security level 1 (λ~128 bits), the sizes of cryptographic components in different signature schemes may be compared as follows. In the Falcon scheme, the public key is 897 bytes, the private key is 1281 bytes, and the signature is 690 bytes. Similarly, in the Dilithium scheme, the public key is 1184 bytes, the private key is 2800 bytes, and the signature is 2044 bytes. In contrast, the traditional ECDSA scheme has smaller sizes, with a public key of 64 bytes, a private key of 96 bytes, and a signature of 64 bytes. In the field of post-quantum cryptography (PQC) schemes, it is important to note that both one-time-use signatures, such as one-time hash-based signatures, and multi-use signatures, such as Falcon signatures, coexist as well.

Among the various post-quantum cryptographic (PQC) schemes, one family that stands out as particularly promising is the lattice-based signature schemes (e.g., Falcon and Dilithium). Lattice-based cryptography relies on the hardness of certain mathematical problems related to lattices, which are structures formed by periodic arrays of points in multi-dimensional space. The security of lattice-based schemes is based on the difficulty of a limited class of lattice problems ranging from the “Shortest Vector Problem” (SVP), the “Closest Vector Problem” (CVP), the “Short Integer Solution Problem” (SISP), or the “Ring Learning With Error Problem” (RLWEP), which are believed to be resistant to quantum attacks.

Efficient lattice-based signature schemes, whether in software or hardware implementations, often establish their security through proofs in the random oracle model. These schemes can be broadly categorized into two families: the hash-and-sign family (e.g., Falcon) and signatures based on identification schemes, employing the Fiat-Shamir heuristic (e.g., Dilithium) or a related variation.

In digital signature schemes following the hash-and-sign paradigm, a specific criterion is adhered to: prior to being signed, a message u undergoes a hashing process. This entails hashing u into a certain point h=H(μ), with the condition that h falls within the domain of a designated trapdoor function f. Subsequently, after the message has been hashed, it becomes eligible for signing, leading to the creation of s=f−1(h). Verification of the validity of a message/signature pair (σ, μ) hinges on a verification algorithm that ascertains whether the equation f(s)=H(μ) holds true. The connection between lattices and hash-and-sign signatures is rooted in the insight that a concise basis for a lattice could potentially provide the aforementioned trapdoor function. Conversely, digital signature schemes formulated within the Fiat-Shamir paradigm take a different approach. They commence as identification schemes and are then transformed through a Fiat-Shamir transformation, a process that facilitates their conversion into signature schemes.

In almost all lattice-based signature verification processes, a central computation involves computing lattice vectors using matrix-vector multiplication for verifying the validity of the lattice-based signature and ensuring the authenticity and integrity of the signed message. Additional steps may be further required such as performing a range check and ensuring that the norm of the signature is below a predetermined threshold value.

### 5. Solution Provided by the Present Disclosure

The general principle is to enable one or more blockchain blocks to be generated during a period of time required to generate a proof of validity for a previously generated block. In other words, the herein-described methods allow a proof of validity for a particular block to be generated in parallel to the generation of new blocks on the blockchain. This may be achieved by decoupling the proof of validity generation from the generation of blocks on the blockchain. The herein disclosed methods provide at least the same security guarantees as extant blockchain methods, enabling proving systems to be used at the base layer of blockchains without sacrificing security or scalability. At least two embodiments of how proof of validity may be decoupled from block generation are envisaged, and described below.

### a) Immutable Blocks

### 1. Working Principle

The general principle of this embodiment is to incorporate one or more generated proofs of validity into a block being currently generated. The one or more proofs of validity may relate to validity data included in one or more previously generated blocks, i.e., data enabling the verification of transaction data comprised in the one or more previously generated blocks. The previously generated blocks may precede the block being currently generated by a time period equal to or greater than the time required to generate the one or more proofs of validity. Accordingly, the validity data stored in a block may be replaced with a proof of validity stored in a later block. More specifically, in accordance with some embodiments the data related to the proof of validity (validity data) of a block i is not stored in block i, and instead the proof of validity for block i is stored in a block i+k±j, where k is a parameter representing the latency of generating a proof of validity for block i measured with respect to the number of blocks generated since block i was generated, and j is a variable to dynamically change the window size determined by k. The adjustment of parameter k may depend on the computing power of the different miners in the network, while parameter j may depend on the stability of the blockchain network (e.g., stability of Internet connection) and be adjusted accordingly. During the time k±j for which a proof of validity is being generated, the original transaction data is accessible by miners in a shared database to allow intermediary blocks to be generated, thus preserving the functionality of the blockchain. Data for which the proof of validity is being generated is temporarily (during the time k±j) moved off-chain into a publicly available database accessible to the miners, while the proof of validity is being generated. Once the proof of validity has been generated it is stored in the most recently generated block on the blockchain. Note that indies i, k and j could also relate to time lapses. Whether the time latency required to generate the proof of validity is quantified in terms of the number of blocks generated, or the actual time lapse is immaterial for present purposes.

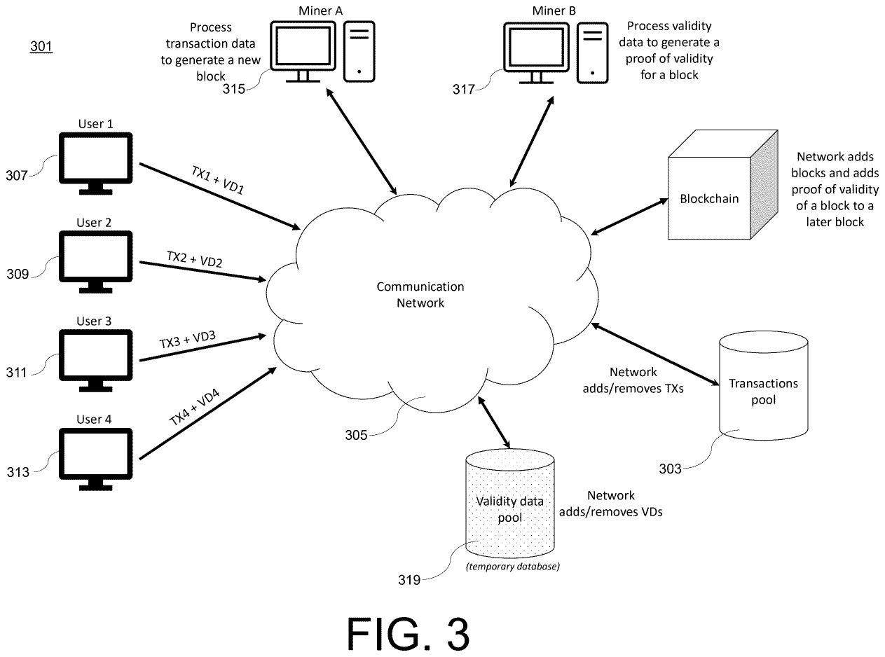

FIG. 3 is a schematic illustration of a networked computer system 301 in which embodiments of the present disclosure may be implemented. FIG. 3 illustrates the networked computer system 301 in which validity data associated with electronic transactions may be integrated together in a blockchain. The illustrated computer system 301 may comprise a blockchain network, in which a ledger of electronic transactions is maintained on a blockchain.

Electronic transaction data generated by different users is collected in a transaction pool repository 303, via a shared communication network 305. A difference with respect to a conventional blockchain network is illustrated here, instead of sending all the global transaction data (e.g. header, data, signature, or any other relevant data) as shown in FIGS. 1 and 2, users specifically send validity data associated with transactions separately from the transaction data. For example, first transaction data TX1 is associated with first data VD1 and a first user at a first user terminal 307; second transaction data TX2 is associated with second validity data VD2 and a second user at a second user terminal 309; third transaction data TX3 is associated with third validity data VD3 and a third user at a third user terminal 311; and fourth transaction data TX4 is associated with fourth validity data VD4 and a fourth user at a fourth user terminal 313. The transaction data is sent to the transaction pool 303 via the shared communication network 305, whilst the validity data is sent to the validity data pool 319. Although illustrated as separate repositories, the validity data pool 319 and the transaction pool 303 may relate to a shared repository. In some embodiments, the transaction pool 303 and the validity data pool 319 may relate to databases. In some embodiments, the database may relate to a decentralised database such as a peer-to-peer database distributed across the network.

Transaction data received by the transaction pool 303 may be stored and subsequently processed by at least one blockchain miner server 315, 317. Validity data received by the validity data pool 319 may be stored and subsequently processed by at least one blockchain miner server 315, 317. In accordance with some embodiments, the same miner server may process both the validity data and the transaction data. Alternatively, a different blockchain miner server may process the validity data than the blockchain miner server processing the transaction data. For example, blockchain miner server A 315 may process the transaction data, and blockchain miner server B 317 may process the validity data. For present purposes, it is immaterial whether the transaction data and the validity data are processed at the same miner server or at separate miner servers. The roles in this context may be interchangeable. A miner server may choose to exclusively generate new blocks and await other miners to provide a (delayed) validity proof, or vice versa. Moreover, a miner server may assume both roles concurrently. The different configurations and role attribution may align with specific incentivization mechanisms and rewarding schemes. It is also to be appreciated that whilst the system of FIG. 3 illustrates two blockchain miner servers 315 and 317, the number of blockchain miner servers comprised in the system is immaterial, provided there is at least one blockchain miner server. In systems comprising two or more blockchain miner servers 315, 317, the different blockchain miner servers may compete to generate the next block in the blockchain and the proof of validity.

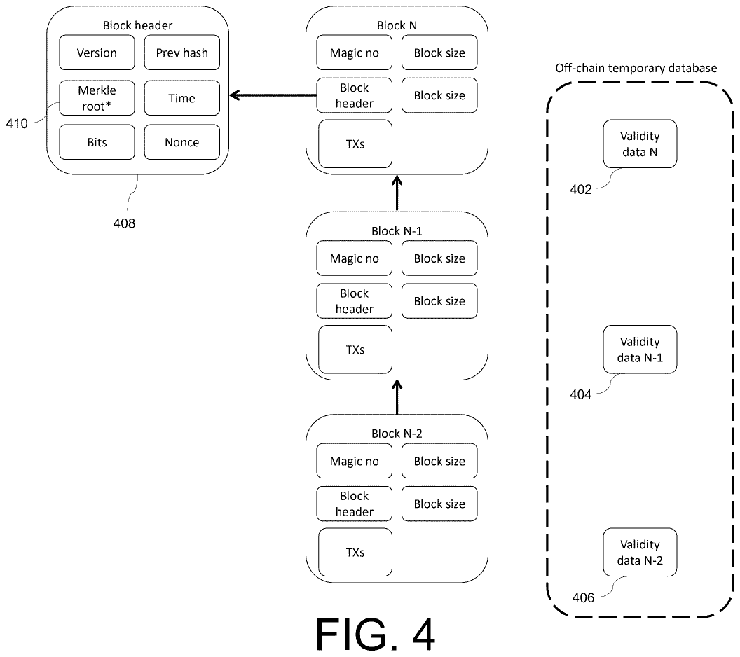

Because the transaction data and the validity data are decoupled, the structure of the blockchain required is non-standard. FIG. 4 is a schematic diagram of a modified blockchain structure that may be used in accordance with the disclosed methods. The main difference with respect to a conventional blockchain structure, such as the blockchain of FIG. 2, is that the validity data 402, 404, 406 associated with the transaction is separated from the transaction data, and stored off-chain on a database, which database may relate to the validity data pool 315, as previously disclosed, or may relate to a distributed database. The database may be accessible by all miners. The block header 408 may be slightly modified as a result of this separation of the validity data from the transaction data, in the sense that the Merkle root hash 410 is the result of a hash of all the transaction data contained in the block, less the validity data. A hash of all the block header is generated and referenced by the next block, as per usual.

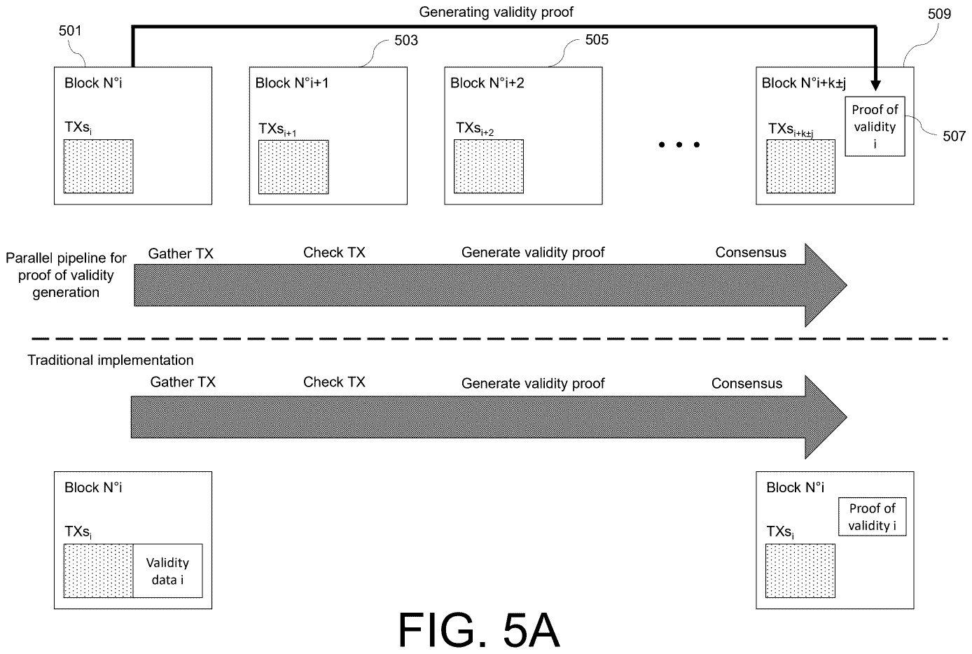

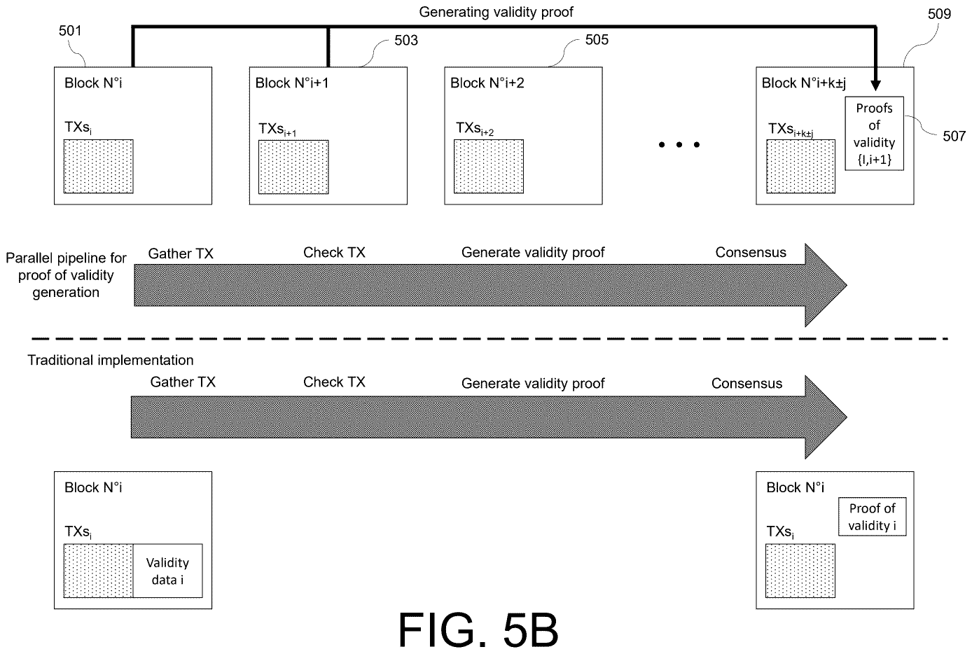

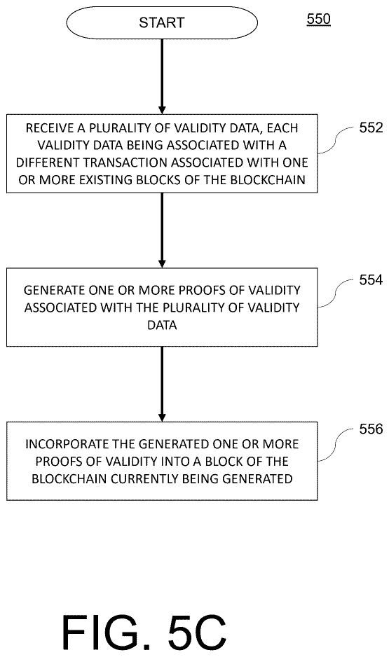

FIG. 5A is a schematic comparative diagram illustrating the schematic structure of blocks in a blockchain where the proof of validity has been decoupled from block generation, in accordance with herein disclosed embodiments, compared with a standard blockchain structure where each block comprises its associated proof of validity. Using the blockchain structure of the herein disclosed embodiments, a proof of validity may be generated in accordance with the following steps:
1. Blocks 501, 503, 505 are generated by the blockchain network, and may contain full block information less the information for which a proof of validity is to be generated for (no proof of validity has been previously provided during block generation). Information related to the proof of validity may be stored in a public database such as validity data pool 319.
2. A miner generates a proof of validity 507 using the information in the public database, i.e. in the validity data pool 319 for block 501. In some embodiments, a plurality of miners may compete with each other to generate the proof of validity.
3. Once the proof of validity has been generated it is included in the block i+k±j 509. Information related to the proof of validity comprised in the validity data pool 319 is removed from the database, once the proof of validity has been added to the block i+k±j 509.
4. Any miner comprised in the network may verify the proof of validity in order to validate the authenticity and integrity of all the data on the network. In particular, miners may have stronger incentives to verify these proofs; if they discover a dishonest entity has produced an invalid proof, then they can simply replace it with a valid proof and claim the reward, as an invalid proof should not be accepted by any participants of the network. Note that verifying a proof of validity, much like verifying the correctness of a mined block, is a process that may take constant time O(1), i.e., it does not depend on the number of transactions or validity data. Accordingly, verifying a proof of validity when generating a block may not introduce any additional latency. Although FIG. 5A illustrates an exemplary embodiment in which a proof of validity is generated for a single block, it is understood that this process may be applied to any plurality of blocks. For example, FIG. 5B, illustrates an exemplary embodiment, in which a proof of validity is generated for two blocks 501, 503, and included in a subsequent block 509.

The block i+k±j may be selected in dependence on the amount of time required to generate the proof of validity. For example, since the time required to generate the proof of validity may be known on the basis of available processing power, and the time required to generate a block of a blockchain is also known, it is possible to express the time required to generate the proof of validity in terms of a number of blocks. In this way, it is possible to establish a fixed rule that the proof of validity for a block i is generated and included in block i+k±j.

In accordance with this embodiment, a miner will eventually generate a proof of validity. This is because the data for which the proof of validity is being generated for is stored off-chain, and will eventually need to be published on-chain. This may be realised by making it a required step for proposing block i+k±j.

FIG. 5C is a flowchart illustrating an exemplary validity proof generation process 550, for use with embodiments comprising immutable blocks, i.e., blocks whose contents cannot be subsequently modified once they have been generated. The process 550 may be implemented by at least one miner server, such as miner servers 315, 317 illustrated in FIG. 3. At step 552, the at least one miner server receives a plurality of validity data may be received. Each validity data may be associated with a different transaction associated with one or more existing blocks of the blockchain, i.e., blocks previously generated. The plurality of validity data may also be received from an accessible database (e.g., validity data pool 319). For example, referring to FIG. 5B, a miner server, such as server 317 of FIG. 3, may receive a plurality of validity data associated with transactions included in the existing and previously generated blocks 501 and 503.

The at least one miner server then generates one or more proofs of validity associated with the plurality of validity data, at step 554. For example, and referring to FIG. 5B, the at least one miner server (e.g. miner 317) may generate a validity proof 507 associated with existing blocks 501 and 503.

Finally, at step 556, the at least one miner server incorporates the generated one or more proofs of validity into a block of the blockchain currently being generated. As shown in FIG. 5B, the at least one miner server (e.g. miner 317) may incorporate the generated one or more validity proofs 507 in block 509, currently being generated. The one or more generated validity proofs (e.g., 507 proofs of validity for block {i, i+1}) may enable verification of transaction data (e.g., TXsᵢ, TXsᵢ₊₁) comprised in the one or more existing blocks (e.g., 501, 503) comprised in the blockchain.

During the time required for generating the validity proof associated with the one or more existing blocks, the validity data associated with the transactions in these blocks, may be temporarily stored in a designated database, such as the validity data pool database 319 of FIG. 3. Once the proof of validity for the validity data of the subject blocks has been generated, and the validity data stored on-chain, the validity data stored in the designated database can be removed from the designated database as it is no longer required. In this sense, the designated database, such as data pool database 319, serves as a temporary storage for validity data, for use in the proof-of-validity generation process. The validity data pool database 319 may be thought of as temporary holding repository for the data (e.g., during a time k±j) for which proofs of validity are actively being generated.

In accordance with this embodiment, each block may comprise the standard information present in a conventional blockchain block (as shown in FIG. 4), with one exception-namely, the validity data associated with the block's transactions. Specifically, the space conventionally used for storing validity data may be replaced by a proof of validity for the block k±j blocks in the past. In other words, the current block does not include its own proof of validity, and instead may incorporate the proof of validity of a prior block. Because proofs of validity associated with a specific block are generated after the block has been generated, it is possible, that some blocks may not comprise any proofs of validity, in particular for blocks generated by the system before the system has had time to generate any proofs of validity for the blocks of the blockchain. For instance, referring to FIG. 5B, a proof of validity for block 501 (i) and 503 (i+1) is not yet available when block 505 (i+2) is generated. This is why block 505 only comprises its own transaction data (TXSᵢ₊₂).

It should also be noted that the genesis block, denoted as the initial block when i=1, along with potentially one or more subsequent blocks (e.g., i=2, 3, 4 . . . ), contingent on the value of k±j, might exclusively consist of transaction data without any validity proofs linked to prior blocks, since such blocks do not exist.

### 2. EXAMPLE

A non-limiting example of the proposed solution is described for the scenario of generating proofs of validity for a set of digital signatures associated with a plurality of transactions. In accordance with this embodiment, the digital signatures for all the transactions in the associated block are moved off-chain into a database available to the miners. The database may be accessed to generate the proof of validity. In some embodiments, the database may be a publicly available database. Once the proof of validity has been generated it is incorporated into the most current block on the blockchain. The following notation is employed to designate the set of transaction data included in a block i {TX₁, TX₂, . . . , TX_{Ni}}ᵢ and the corresponding set of digital signature is {s₁,s₂, . . . , s_{Ni}}ᵢ, where Nᵢ represents the number of transaction included in the i^{th} block.

Assume the current block is i, the procedure is as follows:
1. Miners work on generating a proof of validity for i^{th} block, i.e. a proof of validity for {s₁,s₂, . . . , s_{Ni}}ᵢ.

Meanwhile for the next k±j blocks:
2. Users 307, 309, 311, and 313 send transactions to the blockchain network for the block at height i+k±j.
3. Miners gather transactions and organise them into a block to propose at height i+k±j. The retained plurality of transactions is {TX₁, TX₂, . . . , TX_{Ni+k±j}}_{i+k±j}.
4. Miners check the validity of the transactions {TX₁, TX₂, . . . , TX_{Ni+k±j}}_{i+k±j}, and optionally of the digital signatures {s₁,s₂, . . . , s_{Ni+k±j}}_{i+k±j}, for the block to be proposed at height i+k±j.
5. Miners execute all instructions required to generate the new block to be proposed at height i+k±j.
6. Miners propose the new block i+k±j which includes the proof of validity for the i^{th} block to the network.
7. Other miners may verify the validity proof of block i and form consensus for the block at height i+k±j. If miners find any invalid proof, they will replace it with a valid proof and claim the reward.

The structure of a blockchain block is modified such that signatures are completely excluded from blocks and only a proof of validity of the signatures for the block is included in a block k±j blocks later. Each block contains the typical information stored in a blockchain block with the exception that the digital signatures associated with the block's transactions are replaced by a proof of validity for the block k±j blocks prior or that their spaces remain vacant. A hash of all the information in that block (block hash) is generated and referenced by the next block, as usual. For the duration of time required to generate the validity proof of block i, the digital signatures {s₁,s₂, . . . , s_{Ni}} i. associated with the transactions {TX₁, TX₂, . . . , TX_{Ni}}ᵢ in the i^{th} block are stored in the validity data pool database 319. Once the proof of validity for the digital signatures {s₁,s₂, . . . , s_{Ni}}ᵢ. for of the i^{th} block is generated, the proof is included in the block at height i+k±j. Since the digital signatures for block, i are now on-chain, they are removed from database 319, which temporarily stores digital signatures while their proofs of validity are being generated. The validity data pool database 319 can thus be seen as a sliding window holding the data (typically during a time k±j) for which proofs of validity are being generated.

### b) Mutable Blocks

### 1. Working Principle

In accordance with another embodiment, data stored in a blockchain block may be replaced with a proof of validity in the same block (as opposed to being stored in a later block as in the previous embodiment). Data required to generate the validity proof stored in a block i may be replaced with a proof of validity generated at the block i+k±j, where k is a parameter representing the latency of generating a proof of validity measured in the number of blocks and j is a variable to dynamically change k. This embodiment requires modifying a previous block without changing the block hash, thus requiring a modification to how the block hash is calculated. Instead of calculating the block hash as the hash of all data available in a block, the data for which a proof of validity is being generated is excluded from the block hash. This provides the flexibility to replace that data with a proof of validity for that data once the proof of validity has been generated while maintaining the ability to add new blocks in the meantime.

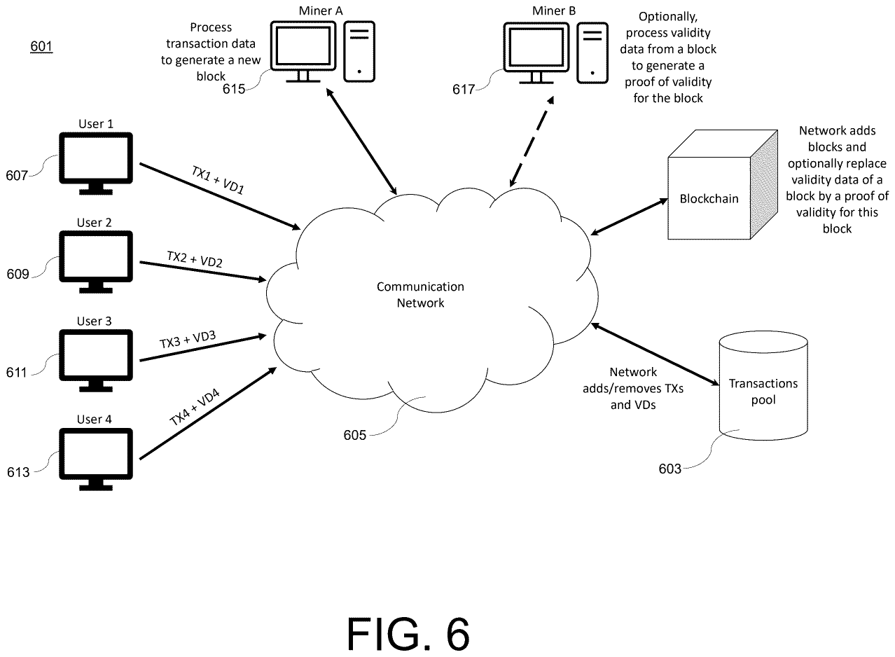

FIG. 6 is a schematic illustration of a networked computer system 601 in which embodiments of the present disclosure may be implemented. FIG. 6 illustrates the networked computer system 601 in which the validity data associated with electronic transactions may be integrated together into a blockchain. The illustrated computer system may comprise a blockchain network, in which a ledger of electronic transactions is maintained on the blockchain, thereby avoiding having to maintain a separate validity data pool 319 as illustrated in FIG. 3.

Electronic transaction data generated by different users 607, 609, 611, 613 is collected together in a transaction pool repository 603, via shared communication network 605. In contrast with previous embodiments, instead of sending all the global transaction data (e.g. header, data, signature, or any other relevant data) as shown in FIGS. 1 and 2, users 607, 609, 611, 613 specifically send the validity data associated with the transactions separately from the transaction data. Similarly, the validity data associated with the transaction may be parsed apart from the transaction data, yet sent together with it. For example, first transaction data TX1 is associated with first validity data VD1 and a first user at a first user terminal 607, second transaction data TX2 is associated with second validity data VD2 a second user at a second user terminal 609, third transaction data TX3 is associated with third validity data VD3 and a third user at a third user terminal 611, and fourth transaction data TX4 is associated with fourth validity data VD4 and a fourth user at a fourth user terminal 613. Both transaction data and validity data are sent to the transaction pool 603 via the shared communication network 605. Although represented as an external database, the transaction data pool 603 may be a shared database (e.g., a peer-to-peer database). Transaction data and validity data received by the transaction pool 603 are stored and subsequently processed by at least one blockchain miner server 615. Another blockchain miner 617 may receive the validity data stored in a block of the blockchain and generate a proof of validity for that block, which may then replace the validity data in the block. Although FIG. 6 illustrates two different miners performing the processing tasks of generating a block and generating a proof of validity separately, it is to be appreciated that a single miner can perform both tasks. The specific roles performed by miners may be interchangeable, with, for example, some miner servers focusing solely on block generation or validity proof production, or both concurrently, depending on specific implementations of the disclosed embodiments. Whether a miner performs one or more different roles may depend on the details of the adopted incentivization structure of the implementing blockchain network. It is also to be appreciated that whilst the system of FIG. 6 illustrates two blockchain miner servers 615 and 617, the number of blockchain miner servers comprised in the system is immaterial, provided there is at least one blockchain miner server, and in some embodiments it is envisaged that the system may comprise a more than two miners. In systems comprising two or more blockchain miner servers 615, 617, the different blockchain miner servers may compete to generate the next block in the blockchain and the proof of validity, as occurs in conventional blockchain systems.

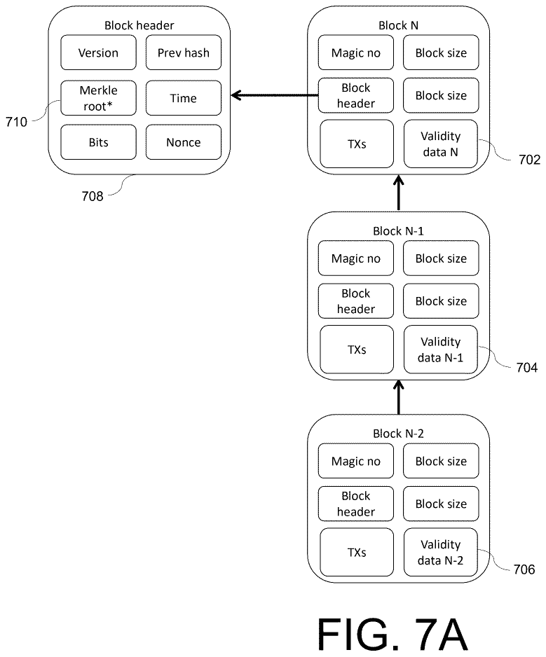

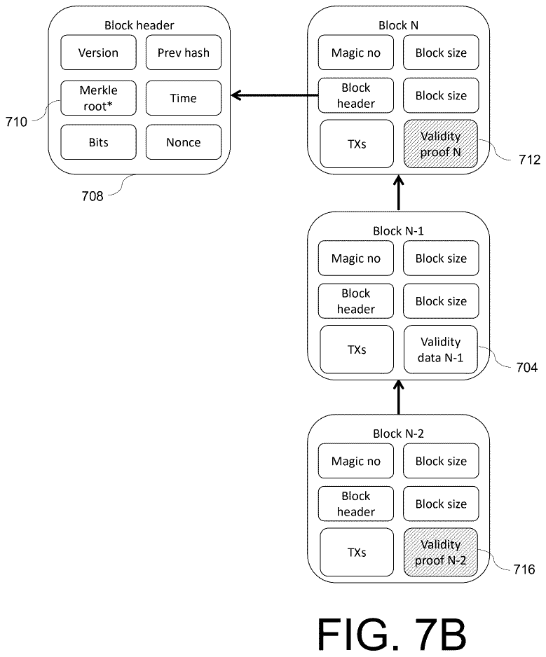

In accordance with the present embodiment, the structure of the blockchain may be non-standard. FIG. 7A is a schematic diagram of an exemplary non-standard blockchain structure for use with the present method. In contrast with a conventional blockchain structure, as shown in FIG. 2, the validity data 702, 704, 706 associated with the transaction are separated from the transaction data. As a result, in some embodiments, the block header 708 may be slightly modified, in the sense that the Merkle root hash 710 is the result of a hash of all the transaction data contained in the block less the validity data. In some other embodiments, the Merkle root hash 710 may result in a hash of all the transaction data contained in the block with the separated validity data. A hash of the block header is generated and referenced by the next block, as usual. FIG. 7B is a schematic diagram of the exemplary non-standard blockchain structure of FIG. 7A, when some of the validity data stored in blockchain blocks are replaced with proofs of validity in the same blocks. More specifically, in this example, validity data for block N 702, and for block N-2 706 have been replaced respectively by validity proof for block N 712 and validity proof for block N-2 716. Validity data for block N-1 704 remain in place in block N-1.

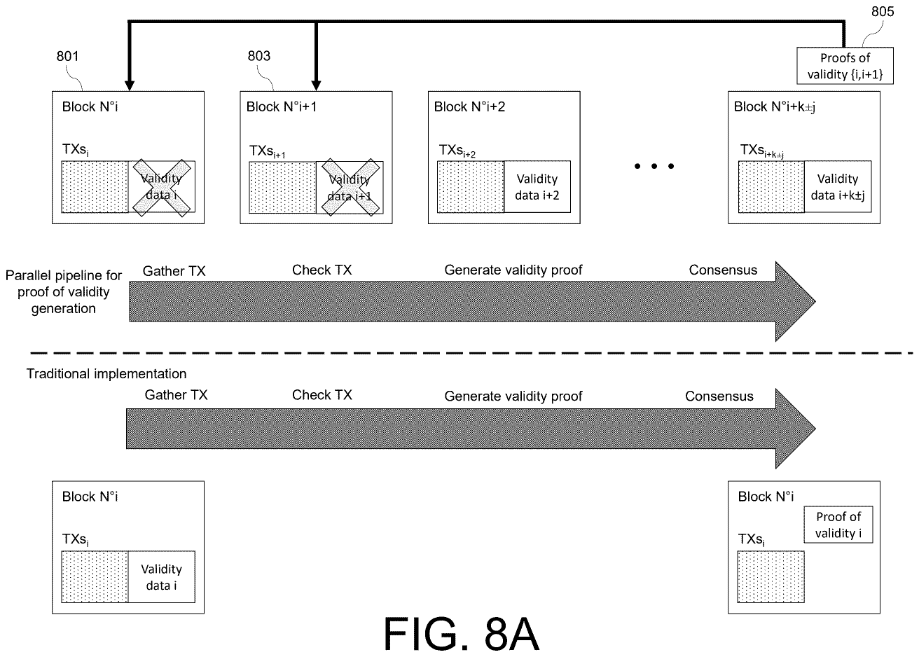

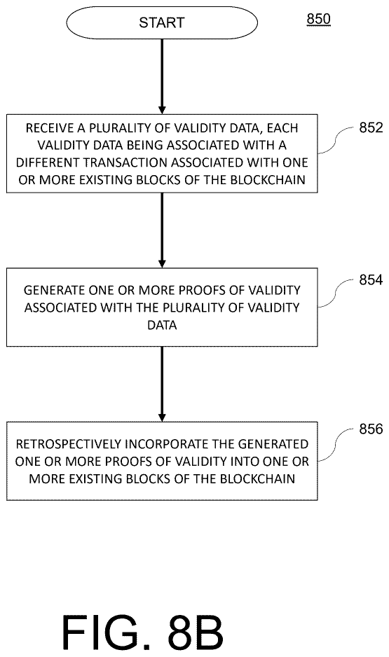

FIG. 8A is a schematic comparative diagram illustrating how another non-standard blockchain may be used in accordance with the herein-disclosed embodiments. Specifically, the illustrated non-standard blockchain may be used by a plurality of miners to generate a proof of validity on the blockchain, in accordance with the herein-disclosed embodiments. In FIG. 8A, the non-standard blockchain is compared with a standard blockchain structure, and how a proof of validity is currently generated on a blockchain. Using the illustrated non-standard blockchain structure, a proof of validity may be generated in accordance with the following method steps:
1. Blocks 801, and 803 are proposed to the network containing full block information. Block hashes are generated using the full block information, less the validity data as recited above.
2. Miners compete to generate proofs of validity 805 for one or more blocks (in this case for the block i and the block i+1).
3. The first miner generates proofs of validity (after a time k±j) and proposes to include the generated proofs in the one or more blocks (in this case at block i and block i+1).
4. Other miners may verify the validity of the proof

Although FIG. 8A illustrates an exemplary embodiment in which a proof of validity is generated for multiple blocks (in this case two), it is understood that this process may be applied to a single block.

FIG. 8B is a flowchart illustrating an exemplary validity proof generation process 850 for mutable blocks, i.e., blocks whose contents may be subsequently modified after they have been generated and placed on the blockchain. Consistent with the disclosed embodiments, such a method of retrospectively modifying an existing block of a blockchain, may be executed by at least one miner server, such as miner servers 615, 617 of FIG. 6.

Method 850, commences at step 852, which includes receiving a plurality of validity data. Each validity data may be associated with a different transaction associated with one or more existing blocks of the blockchain, i.e., previously generated blocks. For example, referring to FIG. 8A, a miner server (e.g., miner 617) may receive a plurality of validity data associated with transactions included in the existing and previously generated blocks 801 and 803.

One or more proofs of validity associated with the plurality of validity data are generated at step 854. With reference to FIG. 8A, the at least one miner server may generate validity proof 805 associated with existing blocks 801, 803.

Finally, at step 856, process 850 may comprise retrospectively incorporating the generated one or more proofs of validity into the one or more existing blocks of the blockchain. Retrospectively incorporating the proof of validity into the existing blocks may comprise substituting the validity data stored in those blocks with the subsequently generated proofs of validity. Additionally, the generated one or more proofs of validity may be incorporated into the one or more existing blocks associated with the transactions in respect of which the one or more proofs of validity are associated. As shown in FIG. 8A, the at least one miner server may retrospectively incorporate proof of validity 805 associated with block i 801, in block 801, thereby replacing validity data for this specific block. A similar operation is performed with respect to block i+1 803. Consistent with the present disclosure, the one or more generated validity proofs (e.g., proofs of validity 805 for blocks {i, i+1} ) may enable verification of transaction data (e.g., TXsᵢ, TXsᵢ₊₁) comprised in the one or more existing blocks (e.g., 801, 803) comprised in the blockchain.

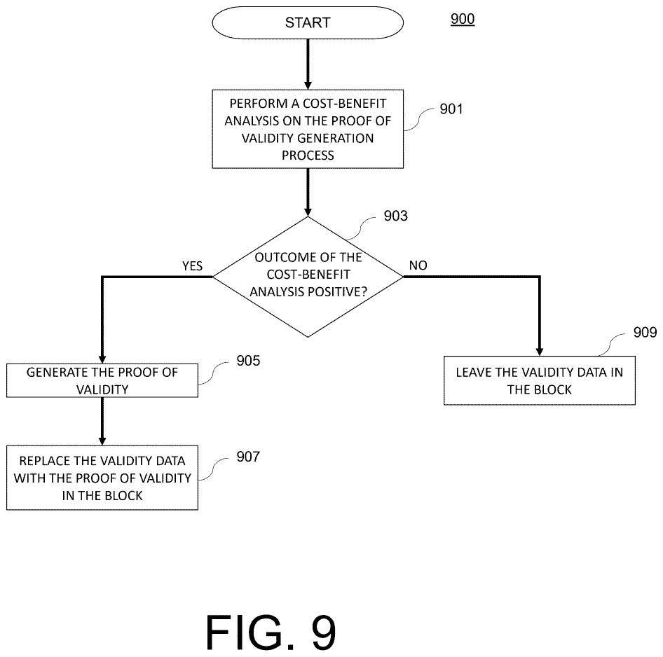

In contrast with the preceding embodiment, this embodiment does not require that a miner eventually generates a proof of validity. This is because the data for which the proof of validity is being generated for is still stored on-chain. The decision to generate the proof of validity may be based on a cost-benefit analysis 900, as illustrated in the flowchart in FIG. 9. Cost-benefit analysis process 900 may be carried out during steps 854 and 856 of process 850. At least one miner, such as miner 617, may perform 901 a cost-benefit analysis for generating a proof of validity for a block. If the outcome of the cost analysis is positive (“YES”), at step 903, the miner will generate the proof of validity, at step 905, and replace the validity data with the proof of validity in the block, at step 907. If the outcome of the cost analysis is not positive (“NO”), at step 903, then, at step 909, the miner does not modify the content of the block and instead leaves the validity data in the block. This may be important in applications where there is no marginal utility of spending computational power to generate a proof of validity. The cost-benefit analysis may be based on a potential reward for the miner, time efficiency, processing efficiency, storage efficiency, energy consumption, or a combination thereof. For example, in some embodiments, the viability of the overall process may depend on the economic balance between the reward earned by a miner server for successfully generating a validity proof, and the energy consumption cost associated with the proof's generation. Should the reward fail to offset the energy cost, the process may be deemed non-beneficial. Likewise, if the time needed to generate the proofs exceeds acceptable time efficiency limits, or the processing overhead negatively impacts (e.g., creates unwanted latencies) the overall efficiency of the blockchain, the generation of proofs of validity may be halted. Conversely, if the storage required for storing the proofs of validity is less than the storage required to store the validity data, thus providing a net storage saving, it may result in a positive cost-benefit analysis, and generation of the proof of validity proceeds. One or more of these factors may be considered in the cost-benefit analysis, recognizing that certain elements, while seemingly detrimental, could yield positive outcomes. For instance, the process of generating one or more proofs of validity, which requires an expenditure of any one or more of time, money, and processing power, may be counterbalanced by the resulting storage savings on the blockchain, resulting in a net positive impact. The cost-benefit analysis considers these factors and the current state of both the blockchain and the associated miner whenever the generation of a proof of validity is contemplated. As a result, the analysis outcome may depend on the content of each proof, and may be contingent on the prevailing conditions of the network and blockchain. Accordingly, it is envisaged that the blockchain may comprise a mixture of blocks containing a proof of validity, and blocks simply containing validity data. Such a mixture of blocks is illustrated for example in FIG. 7B.

In accordance with some embodiments, the cost-benefit analysis may comprise determining if the estimated time required to generate the one or more proofs of validity, is less than or equal to a predetermined time threshold. The cost-benefit analysis may be positive when the determined time is less than or equal to the predetermined threshold, in which case the miner proceeds to generate the one or more proofs of validity. The estimated time may be determined based on available processing resources. Accordingly, a first miner having more processing resources than a second miner, may determine the estimated time as being less than the second miner, due to the difference in available processing resources.

Similarly, in some embodiments, the cost-benefit analysis may comprise determining if the estimated processing overhead required to generate the one or more proofs of validity, is less than or equal to a predetermined processing overhead threshold. The cost-benefit analysis may be positive when the determined processing overhead is less than or equal to the threshold, in which case the miner proceeds to generate the one or more proofs of validity.

### 2. EXAMPLE

A non-limiting example of how this embodiment may be implemented is described with respect to an embodiment in which the proofs of validity are generated for a set of digital signatures associated with a plurality of transactions. Here, the block hash function is modified to exclude the set of digital signatures as input. Assume the current block is block i, the procedure is as follows:
1. Miners continue to propose new blocks in perpetuity, including the set of digital signatures ({s₁,s₂, . . . , s_{Ni}} for block i, {s₁,s₂, . . . , s_{Ni+1}}_{i +1} for block i+1, etc.).
2. If at any time a miner generates a proof of validity for a previous block, the set of digital signatures is replaced by the proof of validity in that block.

### 6. Proof of Validity Generation Exemplary Process: Signature Aggregation

In accordance with an embodiment, when generating a proof of validity for a set of digital signatures associated with a plurality of transactions, the process of generating the proof of validity may comprise the generation of an aggregated signature. One of the primary goals of signature aggregation is to reduce the size and computational overhead of handling multiple signatures and to improve the efficiency and scalability of cryptographic operations. By aggregating multiple signatures into a single signature, the overall data overhead may be reduced, leading to more efficient and manageable communication and storage.

Within the context of a blockchain, where a plurality of transactions are bundled into a block, and each transaction is associated with a signature, signature aggregation may provide several advantages, enhancing the overall efficiency of the blockchain. For example, signature aggregation may significantly reduce the size of each block, by combining multiple signatures into a single aggregated signature. This reduction in block size directly translates to lower storage and bandwidth requirements, resulting in improved scalability and faster transaction processing. Another advantage of signature aggregation is that it may enable some of the computation related to the verification of signatures to be performed off-chain. Rather than executing all computations directly on the blockchain, which can be resource-intensive and slow, off-chain computation utilizes external devices to perform these computations. The results are then verified on-chain, which is more cost-effective than conducting all computations on-chain. The off-chain parties (referred to as the aggregator) may be untrusted and may not require communicating with the on-chain parties. This approach brings significant benefits to blockchain systems, including improved scalability and reduced on-chain resource requirements. For example, referring to FIGS. 3 and 6, Miner B 317, 617, may represent an off-chain aggregator responsible for generating aggregated signatures associated with blocks while Miner A may represent an on-chain miner responsible for generating new blocks.

Within the context of PQC, where lattice-based or other post-quantum cryptographic schemes are used, the reduction in storage requirements associated with signature aggregation is particularly advantageous due to the larger key and signature sizes inherent in many PQC algorithms.

Incorporating an aggregation capacity in a digital signature scheme may comprise the addition of two algorithms (Aggregate, AggregateVerify) that function as follows:

Aggregate((μᵢ, pkᵢ, sᵢ)_{i=1:N})→A: Input a list of N message-key-signature triples (μ₁,pk₁,s₁), . . . , (μ_{N}, pk_{N}, s_{N}) and output an aggregate signature A.

AggregateVerify((μᵢ, pkᵢ)_{i=1:N}, A )→b∈{0, 1}: Input a list of N message-key pairs (μ₁,pk₁), . . . , (μ_{N}, pk_{N}) and an aggregate signature A and output outputs a bit b, indicating whether the signature A is a valid aggregate signature for the given set of message-key pairs.

A digital signature scheme may therefore be defined by a tuple of algorithms (KeyGen, Sign, Verify, Aggregate, AggregateVerify). Some alternative algorithms may necessitate the participation and private keys (sk) of the signing entities in one or more rounds of interaction. Moreover, in certain scenarios, the Verify algorithm may be omitted as its function can be subsumed by AggregateVerify, allowing verification of individual signatures during the verification of the aggregated signature, or alternatively, in the verification phase, only the validity of the aggregated signature may be checked as the aggregated signature may be valid if and only if each individual signature is valid.

Aggregate and AggregateVerify algorithms provide the necessary grounds for compressing digital information without sacrificing its integrity. AggregateVerify enables the aggregated signature to be verified and confirms the ability of aggregate signatures to store compressed transaction information on the blockchain. Indeed, AggregateVerify, which is used as a verification function, ensures that aggregate signatures are correct, and they can be used to verify that the set of transactions on a blockchain represents the true set of valid transactions submitted as input. Executing AggregateVerify on an aggregate signature thus allows a blockchain to verify the resulting aggregate signature before recording it on-chain.

The actual size of aggregated signatures A may vary depending on different scenarios and factors. It is influenced by the specific signature aggregation technique used, the number of signatures being aggregated, the signature scheme itself, and any additional metadata or overhead included in the aggregation process.

In certain scenarios, the signature aggregation scheme may involve a straightforward concatenating process, where the size of the aggregate signature A formed by aggregating N individual signatures (s₁, . . . , s_{N}) is equal to N times the size of an individual signature s, making |A|=|O(N)|=N*|s|. This mode of linear aggregation is, without loss of generality, possible with any signature scheme.

However, in other cases, the aggregated signatures may be more compact, resulting in sublinear size with respect to N. For instance, the size of the aggregate signature may scale logarithmically with N (|A|=|O(In(N))|). In such cases, the aggregated signature becomes more efficient to publish than the N individual signatures in an asymptotic sense. This means that as the number of signatures N increases, the size of the aggregated signature grows more slowly than the linear increase seen when concatenating signatures individually. There is a space-saving effect. Due to the constant factor involved in the asymptotic notation, there exists a threshold concerning the number of signatures N below which no compression or compactness effect is evident. This threshold is determined by the logarithmic scaling. For instance, if the size of the aggregate signature is given by |A|=C1 In(N), where C1≈20*|s|, a space-saving effect will only be noticeable for values of N above 90. Furthermore, the threshold is influenced by any additional data that may be included in the aggregated signature during the aggregation process. As the size of this additional data increases, the threshold will also increase, meaning a higher number of signatures will be needed to observe significant space-saving benefits. The additional data contributes to the overall size of the aggregated signature and affects the point at which the compactness effect becomes apparent. In certain protocols, the public keys (pk₁, . . . , pk_{N}) may be published alongside the aggregated signatures. In such embodiments, assuming a logarithm scaling, space savings may be observed when the number of signatures N satisfies the following conditions: N|pk|+C1 In(N)+C2<N(|pk|+|s|), where C2 is a constant, and |pk| the size of an individual public key. This expression represents the trade-off between the size of the aggregated signature and the space required for publishing the public keys.

The space-saving in aggregated signatures may be achieved by employing composite expressions, which refer to structured and/or condensed representations of the individual signatures employing various mathematical objects or models. For example, a composite expression may correspond to a mathematical construction derived from the individual signatures s, their components, or other associated data (e.g., public keys, messages . . . ) involving various cryptographic functions such as hash functions, random oracles (idealized hash functions) or bilinear pairings. The space-saving (size of aggregated signatures A) may be therefore based on the composite expressions selected. For example, an illustrative use case may involve summing all the signatures and storing the sum as an aggregated signature instead of storing each individual signature separately. If each signature can be represented as a K-bit number, the maximum value of the sum of N K-bit numbers would be N*2K. Using binary logarithm notation, the maximum number of bits required to represent such a sum would be floor(In₂(N*2^{K}))+1, resulting in the size of the aggregated signature scaling logarithmically with N (|A|=|O(In(N))|). Another example that exhibits similar scaling could involve the utilization of a linear combination (rather than a simple sum) where the coefficients are derived from a random oracle. This random oracle is queried on all signatures that are aggregated, and the resulting coefficients are used to compute the linear combination. It should be noted that the space-saving associated with aggregated signatures does not result from any compression techniques. Compression techniques are designed to transform data into a more compact form that can be recovered, or uncompressed, for later use. However, for aggregated signatures, the non-aggregated signatures cannot be recovered from the aggregate signature, in contrast with a compression technique. Instead, the space-saving in aggregated signatures is achieved through other means, such as employing composite expressions and mathematical relationships to efficiently verify the validity of multiple signatures without storing them individually.

As with a non-aggregated signature, an aggregated signature A may also consist of multiple components represented by A=(a₁, . . . , a_{M}′). The total number of aggregated signature components is denoted by M′, and these components may be portions of composite expressions, and may be related to each other through various mathematical relationships.

In most scenarios, aggregate signature schemes preserve security levels within the system. Despite aggregating multiple signatures, the security strength is maintained as the aggregate signature's security level is determined by the weakest link among the individual signatures, as well as by the security of the aggregation algorithm itself.

In accordance with some embodiments, the aggregate signature A may also be generated using a zero-knowledge proof algorithm. For instance, in accordance with an embodiment, an aggregator (prover) may want to prove to have knowledge of a set of N signatures (s₁, . . . , s_{N}) (private witness), and of a function F((μᵢ, pkᵢ, sᵢ)_{i=1:N})=A, without revealing either information. To achieve this, the aggregator may employ zk-SNARK to encode all the relevant information required to validate the individual, non-aggregated signatures into several high-degree polynomials over a finite field, which comprises more elements than the highest degree of these polynomials. For example, the aggregator may compute interpolated polynomials that provide all the signatures being aggregated when evaluated on a subset of the underlying field, along with additional interpolated polynomials that evaluate all the corresponding public keys. Subsequently, the aggregator uses the set (μᵢ, pkᵢ)_{i-1:N} to create unpredictable challenges and generates the proof. In embodiments employing Post-Quantum Cryptography (PQC) in a digital signature scheme, the use of quantum-resistant or post-quantum Zero-Knowledge Proof (ZKP) algorithms may be employed to ensure the security and resistance against potential attacks from quantum computers. One of the examples of such a post-quantum ZKP algorithm is the Aurora algorithm. As for an individual signature, the ZKP proof may be integrated as one of the components of the aggregated signature A and contribute to the overall size of the signature or represent the signature itself A. The size of the aggregated signature, when generated using a ZKP algorithm, depends on the specific proving system that is selected. Not all proving systems will produce the smallest proof size for all types of statements. Therefore, certain proving systems may be more suitable for the aggregation process, as they can offer more efficient and compact proofs in certain scenarios.

Further advantages may be associated with use of Zero-Knowledge Proof (ZKP) techniques in formulating aggregate signature schemes. In the above exemplary embodiment, the aggregator (prover) refrains from disclosing individual signatures to the verifier. Consequently, these signatures may be entirely omitted from the resultant aggregate signature, yielding significant space savings.

In some embodiments, a non-zero-knowledge proving system may be employed. Whilst this approach might, in some circumstances, expose certain non-zero information pertaining to the private witnesses (in this context, the individual signatures), this may be acceptable within the framework of an aggregate signature scheme, since in many applications, digital signatures may not encompass any private or sensitive information. It is important to be appreciated that employing digital signatures as a means of validity proof is just one among various possibilities for data that may fulfil the role of a validity proof. Various types of data linked to transactions on a blockchain or blocks may be incorporated into a validity proof through a process of compression and/or aggregation.

### 7. Execution on Physical Devices

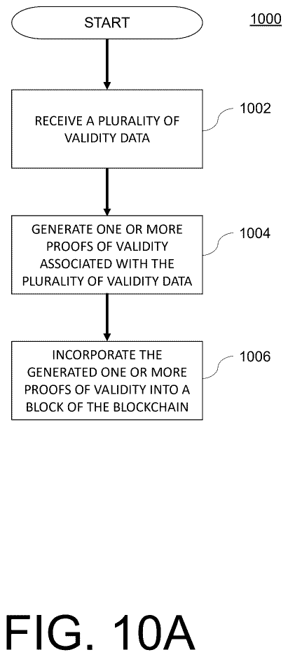

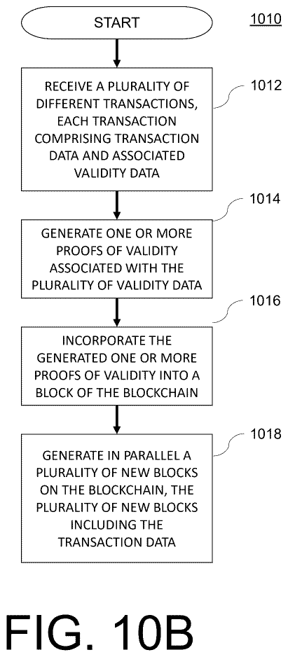

FIG. 10A illustrates how blockchain miner server 315, 317, 615, 617 interacts with user transactions to delay generation and integration of proofs of validity into a block of the blockchain, in accordance with herein disclosed embodiments. Miner server 315, 317, 615, 617 receives a plurality validity data, VD, from communication network 305, 605 as detailed in step 1002 of FIG. 10A. The validity data may be sent by a user, such as a user on a user terminal 307, 309, 311, 313, 607, 609, 611, 613, and stored in blocks of the blockchain, in the transactions pool 603, or in validity data pool 319. In some embodiments, the received plurality of validity data VD may correspond to a plurality of digital signature or signature data s, and each signature data may be associated with a different transaction associated with one or more existing blocks of the blockchain. Each transaction may be associated with a distinct public-private key pair (pkᵢ, skᵢ), selected using a digital signature scheme (e.g., KeyGen, Sign, Verify). The signature data sᵢ associated with a transaction may be generated by encrypting the transaction data TXᵢ with the private key skᵢ associated with that transaction. Additionally, in some further embodiments, each signature data sᵢ may include a plurality of different signature components sᵢ=(S_{i,1}, . . . , S_{i,M}).

In some embodiments, the signatures sᵢ associated with the plurality of different transactions TXs are multi-use signatures. Furthermore, in some other embodiments, the signature data sᵢ and the corresponding public pkᵢ and secret key skᵢ pair may be generated using a post-quantum cryptography digital signature scheme. By using post-quantum cryptography for signature generation, the blockchain network may enhance its security and future-proof the system against potential threats posed by quantum computing advancements. More specifically, in some embodiments, the post-quantum cryptography digital signature scheme is a lattice-based cryptography digital signature scheme. Examples of lattice-based cryptography digital signature schemes include Falcon, Dilithium qTESLA, Rainbow, and Bliss digital signature schemes. In yet further embodiments, the lattice-based cryptography digital signature scheme is a Hash-and-Sign signature. Falcon signature scheme is an example of Hash-and-Sign lattice-based signature.

Miner servers 315, 317, 615, and 617 may then generate one or more proofs of validity associated with one or more blocks from the plurality of new blocks, based on associated validity data VD, at step 1004. The miner server 315, 317, 615, and 317 incorporates the one or more proofs of validity generated during the preceding step into a block of the blockchain, at step 1006. In an embodiment, the blocks of the blockchain may be immutable. In such a scenario, incorporation of the proofs of validity in the blockchain proceeds as illustrated in FIGS. 5A-C and as described previously in the associated portion of the description. Alternatively, the blocks of the blockchain may be mutable. In such a scenario, incorporation of the proofs of validity in the blockchain proceeds as illustrated in FIG. 8A-B, and as previously described in the associated portion of the description.

In some embodiments, the generation of one or more proofs of validity may include aggregating a plurality of digital signatures. This aggregation process may comprise using an aggregated signature algorithm (e.g., Aggregate) comprising a set of transaction-key-signature triples (TX1, pk1, s1), . . . , (TXN, pkN, sN).

In some embodiments, when the plurality of different transactions includes a number N of transactions, the size of the aggregated signatures A may be smaller than the combined size of all the N individual signatures associated with the plurality of different transactions (Si)_{i=1:N}. Alternatively, the number N of transactions may be greater than a threshold number of signatures Nth below which no compression or compactness effect is evident. Indeed, in some embodiments, the size of the aggregated signature A may be sublinear in size with respect to N. For example, in some embodiments, the size of the aggregate signatures A may scale logarithmically with N (|A|=|O(In(N))|). When the number N of transactions exceeds this threshold (Nth), the aggregated signature becomes increasingly advantageous in terms of space efficiency, as its size grows at a slower rate compared to the cumulative size of individual signatures for each transaction.

In some embodiments, the aggregate signatures A may be generated using a zero-knowledge proof algorithm or a post-quantum zero-knowledge proof algorithm. Examples of post-quantum zero-knowledge proof algorithms may include the Aurora algorithm.

In some embodiments, the aggregated signature A may include a plurality of aggregated signature components A=(a1, . . . , a_{M}′) where M′ denotes the total number of aggregated signature components. These components may be portions of composite expressions, composite expressions, outputs of a cryptographically verifiable computing algorithm, or a combination thereof. Examples of cryptographically verifiable computing algorithms may include a zero-knowledge proof algorithm (e.g., Aurora algorithm, Plonky 2, zk-STARK) or a probabilistic checkable proof. Alternatively, in some other embodiments, the aggregate signature A may include a single component, which may be a composite expression or an output of a cryptographically verifiable computing algorithm.

FIG. 10B illustrates an alternative process on how a blockchain miner server 315, 615 interacts with user transactions to delay generation and integration of proofs of validity into a block of the blockchain, in accordance with herein disclosed embodiments. The miner server 315, 615 receives a plurality of different transactions, each transaction comprising transaction data TX and associated validity data VD from the communication network 305, 605 sent by a user, such as a user on a user terminal 307, 309, 311, 313, 607, 609, 611, 613, the transactions being stored in the transactions pool 303, 603 as detailed in step 1012 of FIG. 10B.

Miner server 315, 615 then validates the incoming transactions, by generating one or more proofs of validity associated with one or more blocks from the plurality of new blocks, based on associated validity data VD, at step 1014. The miner server 315, 615 incorporates the one or more proofs of validity generated during the preceding step in the blockchain, at step 1016. In an embodiment, the blocks of the blockchain may be immutable. In such a scenario, incorporation of the proofs of validity in the blockchain proceeds as illustrated in FIG. 5 and as described previously in the associated portion of the description. Alternatively, the blocks of the blockchain may be mutable. In such a scenario, incorporation of the proofs of validity in the blockchain proceeds as illustrated in FIG. 8, and as previously described in the associated portion of the description.

As stated above, the received plurality of validity data may include a plurality of signature data, and generating one or more proofs of validity may include aggregating the plurality of signature data using an aggregation algorithm to produce one or more aggregated signatures. Accordingly, all the embodiments described earlier in relation with process 1000, illustrated in FIG. 10A, remain valid and are incorporated herein in their entirety without and are not restated.

Once the number of received transactions reaches a threshold number of transactions, which threshold may be predetermined, the miner server 315, 615 may start to generate in parallel one or more new blocks, at step 1018. The new blocks comprise the transaction. The production of new blocks may comply with a proof-of-work (PoW) protocol; the miner server 315, 615 may generate a cryptographic hash below a target hash to prove to the network 305, 605 that a certain amount of computational effort has been devoted to the received transactions; the miner server 315, 615 proposes the new block to the network 305, 605; and, a consensus is reached which results in the addition of the block to the blockchain. PoW is just one of several consensus mechanisms that may be employed. In alternative scenarios, different consensus mechanisms such as proof-of-stake protocols or any other suitable consensus mechanisms might be utilized.

In both the block generation and validity proof generation processes, miners may engage in a competitive mechanism. The likelihood of winning a reward usually aligns approximately with the computational power possessed by each individual miner.

### 8. Miscellaneous

In the disclosed embodiments, blockchain transactions are still considered immutable in the sense that they are final according to the traditional blockchain consensus protocol. No third party can tamper with any transaction details after they are accepted by the network. The question about immutability/mutability refers exclusively to the structure of the blockchain. In accordance with one of the herein disclosed embodiments the blocks are immutable, in the sense that once a new block is generated, its content can never be changed or altered. In accordance with an alternative embodiment disclosed herein, the blockchain itself is mutable in one specific way, in that validity data in a block may be replaced by a proof of validity.

Methods and protocols of the present disclosure specify the outcomes miners have to achieve to claim rewards, allowing miners the freedom to choose their preferred methods for achieving these results. This flexibility extends to the hardware used by miner servers. For instance, the overall computing power of each miner may vary and may change based on competition and the number of miners recruited. In the early stages, when the network is small and competition is limited, using general-purpose computers or GPUs might be more practical. As competition intensifies, it may become more advantageous to employ specialized hardware tailored for mining operations.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described functional modules of the miner may be implemented with hardware and/or software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification, which examples are to be construed as nonexclusive.

Other embodiments will be apparent from consideration of the specification and practice of the embodiments disclosed herein. It is intended that the specification and examples be considered as example only, with a true scope and spirit of the disclosed embodiments being indicated by the following claims.

1. A method of generating a proof of validity associated with one or more transactions associated with one or more existing blocks of a blockchain, the method comprising:
receiving a plurality of validity data, each validity data being associated with a different transaction associated with the one or more existing blocks of the blockchain;
generating one or more proofs of validity associated with the plurality of validity data; and
incorporating the generated one or more proofs of validity into a block of the blockchain.

2. The method of claim 1, wherein incorporating the generated one or more proofs of validity into the block of the blockchain comprises:
retrospectively incorporating the generated one or more proofs of validity into one or more existing blocks of the blockchain.

3. The method of claim 2, wherein the generated one or more proofs of validity are incorporated into the one or more existing blocks associated with the transactions in respect of which the one or more proofs of validity are associated.

4. The method of claim 2 or 3, wherein generating the one or more proofs of validity associated with the plurality of validity data comprises performing a cost-benefit analysis in respect of the proof of validity generation process, and generating one or more proofs of validity associated with the plurality of validity data when the outcome of the cost-benefit analysis is positive.

5. The method of claim 4, wherein the cost-benefit analysis is based on one or more of: a potential reward for a miner generating the one or more proofs of validity, time efficiency, processing efficiency, storage efficiency, energy consumption.

6. The method of claim 5, wherein, when the cost-benefit analysis is based on the potential reward for the miner generating the one or more proofs of validity, the outcome of the cost-benefit analysis is positive if the reward for the miner generating the one or more proofs of validity offsets an energy cost for generating the one or more proofs of validity.

7. The method of claim 5, wherein, when the cost-benefit analysis is based on storage efficiency, the outcome of the cost-benefit analysis is positive if a space-saving resulting from storage of the one or more generated proofs of validity compared with the storage required to store the associated validity data, is greater than or equal to a threshold.

8. The method of claim 1, wherein incorporating the generated one or more proofs of validity into a block of the blockchain comprises:
incorporating the generated one or more proofs of validity into a block of the blockchain currently being generated, the one or more proofs of validity enabling verification of transaction data comprised in one or more previously generated blocks comprised in the blockchain.

9. The method of claim 8, wherein the one or more previously generated blocks precede the block currently being generated by a time period equal to or greater than the time required to generate the one or more proofs of validity.

10. The method of claim 8 or 9, wherein the one or more previously generated blocks precede the block currently being generated by a predetermined number of blocks on the blockchain, the time taken to generate the predetermined number of blocks being proportional to a time period equal to or greater than the time required to generate the one or more proofs of validity.

11. The method of claim 9 or 10, wherein the time period is parametrized by at least two parameters k and j, and the time period is equal to k±j.

12. The method of claim 11, wherein the value of the parameter k is dependent on a computing power associated with at least one miner associated with the blockchain, and the parameter j is associated with the stability of the blockchain network.

13. The method of any preceding claim, wherein the method comprises:
receiving the plurality of validity data from a database accessible to one or more miners comprised in a blockchain network.

14. The method of any one of claims 1 to 13, wherein the method comprises:
receiving the plurality of validity data from a database distributed across a plurality of nodes comprised in a blockchain network.

15. The method of claim 14, wherein the method comprises:
receiving the plurality of validity data from a peer-to-peer distributed database.

16. The method of any preceding claim, wherein the database exclusively comprises validity data.

17. The method of any preceding claim, wherein the received plurality of validity data includes a plurality of signature data, sᵢ, each signature data being associated with a different transaction associated with the one or more existing blocks of the blockchain.

18. The method of claim 17, wherein each transaction is associated with a public key, pkᵢ, and private key, skᵢ, pair, the public and private key pair being generated according to a digital signature scheme, and the signature data, sᵢ, associated with a transaction is generated by encrypting transaction data, TXᵢ, associated with the transaction, with the private key, skᵢ, associated with the transaction.

19. The method of claim 18, wherein the digital signature scheme is a multi-use signature scheme.

20. The method of claim 18 or 19, wherein the digital signature scheme is a post-quantum digital signature scheme.

21. The method of claim 20, wherein the post-quantum digital signature scheme is a lattice-based cryptographic digital signature scheme.

22. The method of claim 21, wherein the lattice-based cryptographic digital signature scheme is a hash-and-sign lattice-based cryptographic digital signature scheme.

23. The method of claim 22, wherein the hash-and-sign lattice-based cryptographic signature scheme is the Falcon signature scheme.

24. The method of any one of claims 17 to 23, wherein generating one or more proofs of validity includes aggregating the plurality of signature data using an aggregation algorithm to produce one or more aggregated signatures.

25. The method of claim 24, wherein a size of each of the one or more aggregated signatures is smaller than the combined sizes of the individual signature data being aggregated.

26. The method of claim 24 or 25, wherein a size of the one or more aggregated signatures is sublinear in relation to the total number of signature data being aggregated.

27. The method of any of claims 24 to 26, wherein the size of the one or more aggregated signatures scales logarithmically with respect to the total number of signature data being aggregated.

28. The method of any preceding claim, further comprising:
receiving a plurality of different transactions, each transaction comprising transaction data, TXᵢ;
generating a plurality of new blocks on the blockchain in parallel, the plurality of new blocks including the transaction data.

29. A server comprising a processor, the processor being configured to:
receive a plurality of validity data, each validity data being associated with a different transaction associated with the one or more existing blocks of the blockchain;
generate one or more proofs of validity associated with the plurality of validity data; and
incorporate the generated one or more proofs of validity into a block of the blockchain.

30. The server of claim 29, wherein the processor is configured to:
retrospectively incorporate the generated one or more proofs of validity into one or more existing blocks of the blockchain.

31. The server of claim 30, wherein the processor is configured to:
incorporate the one or more generated proofs of validity into the one or more existing blocks associated with the transactions in respect of which the one or more proofs of validity are associated.

32. The server of claim 30, wherein the processor is configured to:
perform a cost-benefit analysis in respect of the proof of validity generation process, and generate one or more proofs of validity associated with the plurality of validity data when the outcome of the cost-benefit analysis is positive.

33. The server of claim 32, wherein the processor is configured to perform the cost-benefit analysis based on any one of: a potential reward for generating the one or more proofs of validity, time efficiency, processing efficiency, storage efficiency, energy consumption.

34. The server of claim 29, wherein the processor is configured to:
incorporate the generated one or more proofs of validity into a block of the blockchain currently being generated, the one or more proofs of validity enabling verification of transaction data comprised in one or more previously generated blocks comprised in the blockchain.

35. The server of claim 34, wherein the one or more previously generated blocks precede the block currently being generated by a time period equal to or greater than the time required to generate the one or more proofs of validity.

36. The server of claim 34 or 35, wherein the one or more previously generated blocks precede the block currently being generated by a predetermined number of blocks on the blockchain, the time taken to generate the predetermined number of blocks being proportional to a time period equal to or greater than the time required to generate the one or more proofs of validity.

37. The server of claim 35 or 36, wherein the processor is configured to parametrize the time period by at least two parameters k and j, and the time period is equal to k±j.

38. The server of claim 37, wherein the value of the parameter k is dependent on a computing power associated with at least one miner associated with the blockchain, and the parameter j is associated with the stability of the blockchain network.

39. The server of any one of claims 29 to 38, wherein the processor is configured to:
receive the plurality of validity data from a database accessible to one or more miners comprised in a blockchain network.

40. The server of any one of claims 29 to 39, wherein the processor is configured to:
receive the plurality of validity data from a database distributed across a plurality of nodes comprised in a blockchain network.

41. The server of claim 40, wherein the processor is configured to:
receive the plurality of validity data from a peer-to-peer distributed database.

42. The server of any one of claims 29 to 41, wherein the database exclusively comprises validity data.

43. The server of any one of claims 29 to 42, wherein the received plurality of validity data includes a plurality of signature data, sᵢ, each signature data being associated with a different transaction associated with the one or more existing blocks of the blockchain.

44. The server of claim 43, wherein each transaction is associated with a public key, pkᵢ, and private key, skᵢ, pair, the public and private key pair being generated according to a digital signature scheme, and the signature data, sᵢ, associated with a transaction is generated by encrypting transaction data, TXᵢ, associated with the transaction, with the private key, skᵢ, associated with the transaction.

45. The server of claim 44, wherein the digital signature scheme is a multi-use signature scheme.

46. The server of claim 44 or 45, wherein the digital signature scheme is a post-quantum digital signature scheme.

47. The server of claim 46, wherein the post-quantum digital signature scheme is a lattice-based cryptographic digital signature scheme.

48. The server of claim 47, wherein the lattice-based cryptographic digital signature scheme is a hash-and-sign lattice-based cryptographic digital signature scheme.

49. The server of claim 48, wherein the hash-and-sign lattice-based cryptographic signature scheme is the Falcon signature scheme.

50. The server of any one of claims 43 to 49, wherein the processor is configured to generate one or more proofs of validity, comprising aggregating the plurality of signature data using an aggregation algorithm to produce one or more aggregated signatures.

51. The server of claim 50, wherein a size of each of the one or more aggregated signatures is smaller than the combined sizes of the individual signature data being aggregated.

52. The server of claim 50 or 51, wherein a size of the one or more aggregated signatures is sublinear in relation to the total number of signature data being aggregated.

53. The server of any of claims 50 to 52, wherein the size of the one or more aggregated signatures scales logarithmically with respect to the total number of signature data being aggregated.

54. The server of any preceding claim, wherein the processor is further configured to:
receive a plurality of different transactions, each transaction comprising transaction data, TXᵢ;
generate a plurality of new blocks on the blockchain in parallel, the plurality of new blocks including the transaction data.
